(19) United States
(12) Patent Application Publication
(10) Pub. No.: US 2025/0019563 A1
(43) Pub. Date: Jan. 16, 2025

(54) COMPOSITION INCLUDING ADDITION CONDENSATION PRODUCT OF AROMATIC COMPOUND AND CARBONYL COMPOUND AND THIOL COMPOUND, METHOD FOR PRODUCING COMPOSITION, SCALE ADHESION PREVENTION AGENT, REACTION APPARATUS, POLYMER, AND METHOD FOR PRODUCING POLYMER

(71) Applicant: Shin-Etsu Chemical Co., Ltd., Tokyo (JP)

(72) Inventors: Yoshikatsu TSUCHIYA, Ibaraki (JP); Masahiro USUKI, Ibaraki (JP)

(21) Appl. No.: 18/764,158

(22) Filed: Jul. 4, 2024

(30) Foreign Application Priority Data
Jul. 7, 2023 (JP) 2023-112637

(51) Int. Cl. C09D 161/00; B01J 19/02; C08G 16/02; C09D 5/16

(52) U.S. Cl. CPC C09D 161/00; B01J 19/02; C08G 16/0237; C09D 5/1662

(57) ABSTRACT

A composition includes an addition condensation product of an aromatic compound and a carbonyl compound, and a thiol compound. The composition described above includes, for example, 0.01 parts by mass or more and 100 parts by mass or less of a thiol compound per 100 parts by mass of an aromatic compound. In the compositions described above, the addition condensation product may include a first type of addition condensation product having a first average molecular weight and a second type of addition condensation product having a second average molecular weight. In the composition described above, the first average molecular weight and the second average molecular weight are different from each other.

The contents of the following patent application(s) are incorporated herein by reference: NO. 2023-112637 filed in JP on Jul. 7, 2023

### BACKGROUND

### 1. Technical Field

The present invention relates to a composition, a method for producing the composition, a scale adhesion prevention agent, a reaction apparatus, a polymer, and a method for producing the polymer.

### 2. Related Art

Patent Documents 1 to 2 disclose a scale adhesion prevention agent to prevent polymer scale from adhering to the inside of a polymerization vessel.

### PRIOR ART DOCUMENT

### Patent Document

(Patent Document 1) Japanese Patent Publication No. 5445142
(Patent Document 2) Japanese Patent Application Publication No. 2003-40907

### SUMMARY

A first aspect of the present invention provides compositions. The compositions described above include, for example, an addition condensation product of an aromatic compound and a carbonyl compound. The compositions described above include, for example, a thiol compound.

Any of the compositions described above may include 0.01 parts by mass or more and 100 parts by mass or less of the thiol compound per 100 parts by mass of the aromatic compound. In any of the compositions described above, the addition condensation product may include a first type of addition condensation product having a first average molecular weight and a second type of addition condensation product having a second average molecular weight. The first average molecular weight and the second average molecular weight may be different from each other. In any of the compositions described above, the ratio of the mass of the second type of addition condensation product to the mass of the first type of addition condensation product may be 2.3 to 1000. The second average molecular weight may be greater than the first average molecular weight.

In any of the compositions described above, the thiol compound may include a thiol group and at least one functional group selected from a group consisting of a hydroxyl group, an amino group, and a carboxyl group. In any of the compositions described above, the thiol compound may be thioglycerol, thioglycol, or a derivative thereof. The thiol compound may not be a thiourea tautomer.

In any of the compositions described above, the aromatic compound may be naphthols. In any of the compositions described above, the carbonyl compound may be an aldehyde compound or a ketone compound. In any of the compositions described above, the aromatic compound may be 1-naphthol. In any of the compositions described above, the carbonyl compound may be formaldehyde. In any of the compositions described above, the thiol compound may be 1-thioglycerol or thioglycol.

A second aspect of the present invention provides a scale adhesion prevention agent for preventing the adhesion of scale including a polymer. The scale adhesion prevention agent described above includes, for example, any of the compositions according to the first aspect described above.

A third aspect of the present invention provides methods for producing a composition. The methods described above include, for example, a step of preparing a mixture of a solvent, an aromatic compound, a carbonyl compound, and a thiol compound. The methods described above include, for example, a step of causing the aromatic compound and carbonyl compound included in the mixture to react in the presence of a catalyst and a surfactant to produce the composition including the addition condensation product of the aromatic compound and the carbonyl compound and the thiol compound.

In any of the methods described above, the catalyst may be an alkali metal hydroxide. In any of the methods described above, the surfactant may be an anionic surfactant. The thiol compound may not be a thiourea tautomer.

A fifth aspect of the present invention provides a scale adhesion prevention layer. The scale adhesion prevention layer may be formed from the composition of the first aspect described above on the internal structure surface of a reactor included in a reaction apparatus for the polymerization of monomers.

A sixth aspect of the present invention provides a reaction apparatus including a reactor having an internal structure with the scale adhesion prevention layer of the fifth aspect described above formed on the surface.

A seventh aspect of the present invention provides a reaction apparatus. The reaction apparatus described above is used, for example, for the polymerization of monomers. The reaction apparatus described above includes, for example, a reactor that is configured to be able to store the solution including the monomers. In the reaction apparatus described above, the reactor has, for example, a covering layer arranged on at least part of the inner wall surface, which is the surface on the side contacting the solution. In the reaction apparatus described above, the covering layer includes, for example, the addition condensation product of the aromatic compound and the carbonyl compound. In the reaction apparatus described above, the addition condensation product includes, for example, a first type of addition condensation product having a first average molecular weight and a second type of addition condensation product having a second average molecular weight. In the reaction apparatus described above, the second average molecular weight is greater than the first average molecular weight, for example. In the reaction apparatus described above, the ratio of the mass of the second type of addition condensation product to the mass of the first type of addition condensation product is 0.75 to 1000, for example.

An eighth aspect of the present invention provides a method for producing a polymer. The method described above includes, for example, a step of preparing any of the reaction apparatuses according to the seventh aspect described above. The method described above includes, for example, a step of charging a solution including monomers to the inside of a reactor of the reaction apparatus. The method described above includes, for example, a step of starting the polymerization reaction of the monomers inside the reactor. The method described above includes, for example, a step of terminating the polymerization reaction of the monomers inside the reactor.

The ninth aspect of the present invention provides a particulate polymer. In the polymer described above, the number of foreign objects with a major axis of 250 μm or more included per 200 cm3 of the polymer that is measured according to JIS K 6737 is, for example, two or more and four or less. In the polymer described above, the content of the addition condensation product of the aromatic compound and the carbonyl compound in the foreign object is, for example, 1% by mass or more.

### BRIEF DESCRIPTION OF THE DRAWINGS

FIG. 1 schematically illustrates an example of the polymerization apparatus 100.

FIG. 2 schematically illustrates an example of the coating apparatus 190.

FIG. 3 schematically illustrates an example of the production method for a composition.

FIG. 4 schematically illustrates an example of the production method for a polymer.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are necessary for the solutions of the invention. In the present specification, when a numeric range is written as “A to B”, said writing means A or more and B or less.

In the present specification, the ratio of B to A means B/A. For example, the ratio of the mass My of Y to the mass Mx of X means My/Mx. The ratio described above may be represented as a percentage.

In the present specification, the term “compound” means the compound and/or the salt of the compound. For example, in the present specification, the term “thiol compound” means the thiol compound and/or the salt of the thiol compound. The term “aromatic compound” means the aromatic compound and/or the salt of the aromatic compound. The term “carbonyl compound” means the carbonyl compound and/or the salt of the carbonyl compound. The term “aldehyde compound” means the aldehyde compound and/or the salt of the aldehyde compound. The term “ketone compound” means the ketone compound and/or the salt of the ketone compound. Similarly, in the present specification, the term “addition condensation product” means the addition condensation product and/or the salt of the addition condensation product.

### (Overview of the Polymerization Apparatus 100)

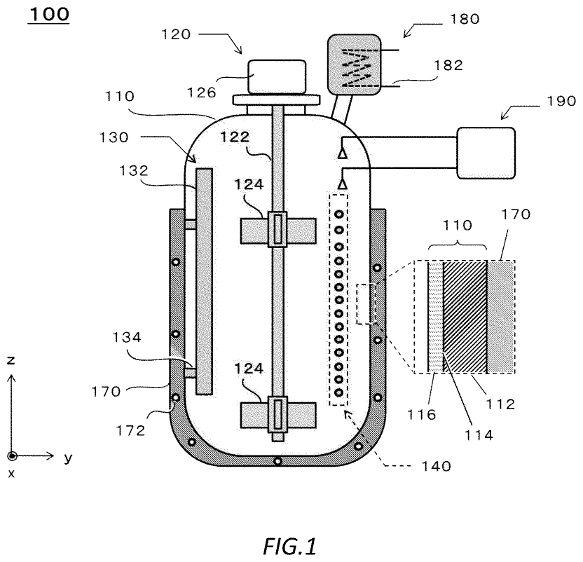

An example of the polymerization apparatus 100 is described with reference to FIG. 1. The polymerization apparatus 100 is used, for example, for the application in which monomers are polymerized to produce a polymer. The polymerization apparatus 100 may be used for the application of suspension polymerization. The method for producing a polymer using the polymerization apparatus 100 is described below in detail.

The monomers described above may be ethylenically unsaturated group-containing monomers. The examples of the ethylenically unsaturated group-containing monomers described above include a vinyl halide such as vinyl chloride; a vinylidene halide such as vinylidene chloride; a vinyl ester such as vinyl acetate and vinyl propionate; acrylic acid, methacrylic acid, and esters or salt thereof; maleic acid, fumaric acid, and esters or acid anhydride thereof; conjugated diene-based monomers such as butadiene, chloroprene, or isoprene; styrene; acrylonitrile; vinyl ether, or the like. The ethylenically unsaturated group-containing monomers described above may be vinyl-based monomers. The vinyl-based monomers described above may be vinyl chloride.

As described in Patent Documents 1 and 2, when the polymer is produced by polymerizing monomers inside the reaction vessel, a part of the polymer may adhere to the inside of the reaction vessel as polymer scale. For example, as the degree of the adhesion of the polymer scale increases with the increase in the number of polymerization batches, the yield of the polymer, the cooling capability of the reaction vessel, or the like decreases. In addition, when the polymer scale adhering to the reaction vessel falls off from the reaction vessel during the production of the polymer, the quality of the polymer obtained as a product may decrease.

Specifically, the proportion of foreign objects contaminating the product increases. The polymer scale described above that has fallen off from the reaction vessel may be an example of a foreign object. For example, if polyvinyl chloride is produced, the product of polyvinyl chloride is obtained as white particles. When a part of the product is sampled and observed through visual observation or a microscope, it may be found that colored particles contaminate the white particles. The colored particles may be, for example, brown particles.

When the polymer scale adheres to the reaction vessel, the work for removing the polymer scale is performed. When the polymer scale adhering to the reaction vessel is to be removed, various works are performed while protecting workers from unreacted monomers included in the polymer scale. Because the removal of the polymer scale requires a lot of effort and time, various scale adhesion prevention agents are being developed to reduce the effort and time needed for the removal work.

The inventor found that some types of scale adhesion prevention agents cannot achieve the scale adhesion prevention effect expected from the experimental result at a laboratory level if the reaction vessel is coated with the scale adhesion prevention agent. With this regard, when the inner surface of the reaction vessel is coated with the scale adhesion prevention agent, the scale adhesion prevention agent is often introduced into the reaction vessel by using steam (for example, see Patent Document 2). As the result of an assiduous examination, the inventor found that the active ingredient in the scale adhesion prevention agent decreases when the scale adhesion prevention agent is heated with steam. It is estimated that the active ingredient described above decreases due to, for example, thermal decomposition.

When the inventor adjusted the constitution of the scale adhesion prevention agent based on the findings described above, the inventor found that, depending on the constitution of the scale adhesion prevention agent, when the scale adhesion prevention agent is introduced into the reaction vessel by using steam, the active ingredient of the scale adhesion prevention agent undergoes thermal decomposition and, as a result, may become difficult to be used as a scale adhesion prevention agent. As a result of an assiduous examination, the inventor found that the thermal decomposition of the active ingredient may be suppressed by adding a thiol compound to the solvent of the scale adhesion prevention agent.

In addition, the inventor found that coating the inside of the reaction vessel with the composition described above may suppress the formation of accretion of the coating film and the polymer scale even if the number of polymerization batches using the reaction vessel increases. In this way, the contamination of the foreign object into the product is suppressed. As a result, the polymer with a small contamination amount of the foreign object is obtained. Examples of the reaction vessel described above include a reaction vessel for producing a polymer by polymerizing monomers. Examples of the monomer include a monomer having an ethylenic double bond.

### (Overview of Each Unit of the Polymerization Apparatus 100)

FIG. 1 schematically illustrates an example of the cross-section of the polymerization apparatus 100. In the present embodiment, the polymerization apparatus 100 includes a reaction vessel 110, a stirrer 120, one or multiple (sometimes simply referred to as one or more) baffles 130, one or more cooling tubes 140, a jacket 170, a reflux condenser 180, and a coating apparatus 190.

In the present embodiment, the reaction vessel 110 includes a body 112 and a scale prevention layer 116 formed on at least part of the inner surface 114 of the body 112. In the present embodiment, the stirrer 120 includes a stirring shaft 122, a stirring blade 124, and a power mechanism 126. In the present embodiment, the baffle 130 includes a body 132 and one or more supports 134. In the present embodiment, the jacket 170 includes a flow channel 172 for a heat medium. In the present embodiment, the reflux condenser 180 includes a flow channel 182 for a heat medium.

In the present embodiment, the stirring shaft 122 and the stirring blade 124 are arranged inside the reaction vessel 110. In the present embodiment, each of the one or more baffles 130 is arranged inside the reaction vessel 110. In the present embodiment, each of one or more cooling tubes 140 is arranged inside the reaction vessel 110.

In the present embodiment, the power mechanism 126 is arranged outside the reaction vessel 110. In the present embodiment, the jacket 170 is arranged outside the reaction vessel 110. In the present embodiment, the reflux condenser 180 is arranged outside the reaction vessel 110.

In the present embodiment, the reaction vessel 110 is configured to be able to store the raw material for synthesis reaction (for example, polymerization reaction). Examples of the synthesis reactions include the polymerization reaction to produce the polymer by polymerizing monomers. If the polymerization apparatus 100 is used for the production of the polymer, the reaction vessel 110 stores the solution including the monomers.

If the polymerization apparatus 100 is used for the production of the polymer, first, the solution including, for example, a polymerizable monomer, a polymerization initiator, an aqueous medium, and a dispersing aid is charged into the reaction vessel 110. The polymerization is then started. Subsequently, the polymerization is stopped. In this way, the polymer is produced. Any surfactant may be used as a dispersing aid.

In the present embodiment, the body 112 of the reaction vessel 110 includes, for example, a straight body portion having a cylindrical shape and a bottom plate connected to the straight body portion. The body 112 may further include a top plate connected to the straight body portion. The bottom plate and the top plate are sometimes referred to as mirror plates. In the present embodiment, the top plate is connected to one end of the straight body portion, and the bottom plate is connected to the other end of the straight body portion. The reaction vessel 110 is, for example, installed such that the extending direction of the straight body portion (z-direction in the figure) is in the vertical direction. In this case, the top plate is arranged above the bottom plate.

Examples of the shapes of the cross-section (sometimes referred to as transverse section) obtained by cutting the straight body portion through the plane perpendicular to the extending direction of the straight body portion (in the figure, x-y plane) include a circle, an oval, a polygon, or the like. It is noted that the shape of the transverse section of the reaction vessel 110 may be a shape that can be considered substantially as a circular, oval, or polygonal shape. Examples of the polygon include a quadrilateral, a hexagon, an octagon, or the like.

The inner capacity of the body 112 (sometimes referred to as the capacity of the reaction vessel 110) is not particularly limited, but the inner capacity of the body 112 may be 0.01 m³ or more and is preferably 0.01 to 600 m³ from the viewpoint of repeatability.

The inner capacity of the body 112 is, for example, 1 to 300 m³. The lower limit value of the inner capacity of the body 112 may be 40 m³, may be 80 m³, may be 100 m³, may be 120 m³, may be 130 m³, may be 150 m³, may be 200 m³, or may be 250 m³. The upper limit value of the inner capacity of the body 112 may be 300 m³ or more. The upper limit value of the inner capacity of the body 112 may be 350 m³ or may be 400 m³.

The inner capacity of the body 112 is defined as the capacity of the body 112 that stores liquid up to the predetermined upper limit position of the body 112. The inner capacity of the body 112 is, for example, the volume of the inside of the body 112 without internal structures such as a stirring shaft, a blade, a baffle, a coil, or the like arranged inside the body 112.

As described above, in the present embodiment, the scale prevention layer 116 is formed on at least part of the inner surface 114 of the body 112. The inner surface 114 is the surface on the side contacting liquid when the liquid is stored inside the reaction vessel 110. The scale prevention layer 116 is formed on, for example, at least the region of the inner surface 114 of the body 112 that is submerged in the liquid phase when the polymerization apparatus 100 is used for the production of the polymer.

In the present embodiment, the scale prevention layer 116 is formed of the composition including the condensation product of the aromatic compound and the carbonyl compound, and the thiol compound. The composition may further include at least one of a solvent, a surfactant, or a pH adjusting agent.

For example, at least part of the inner surface 114 of the body 112 is coated with the coating liquid prepared by using the composition described above to form the scale prevention layer 116. The coating liquid may include the composition described above and at least one of a solvent, a surfactant, or a pH adjusting agent.

The scale prevention layer 116 may include a condensation product derived from the composition described above. The condensation product described above may be an addition condensation product. In one embodiment, the scale prevention layer 116 may include particles the main component of which is the condensation product of the aromatic compound and the carbonyl compound. In another embodiment, the scale prevention layer 116 may include the film of the condensation product of the aromatic compound and the carbonyl compound. The coating liquid of the composition described above is described below in detail. In addition, the procedure for forming the scale prevention layer 116 is described below in detail.

In the present embodiment, the stirrer 120 stirs liquid stored inside the reaction vessel 110. In the present embodiment, the stirring shaft 122 holds the stirring blade 124 and rotates the stirring blade 124. In the present embodiment, the stirring blade 124 is attached to the stirring shaft 122 and stirs liquid stored inside the reaction vessel 110.

The shape of the stirring blade 124 is not limited in particular, but a Pfaudler blade, blue margin blade, paddle blade, inclined paddle blade, turbine blade, propeller blade, and combinations thereof are exemplified as the shape of the stirring blade 124. Thus, by rotation of the stirring shaft 122, a discharge flow from the stirring shaft 122 is generated radially toward an outer circumference. The quantity of blades that the stirring blade 124 includes is not limited in particular, but 2 to 6 blades are exemplified as the quantity of the blades described above. An installation position and installation quantity of the stirring blade 124 are not limited in particular, but the stirring blade 124 is preferably installed in multiple layers. As the number of layers of the stirring blade 124, 2 to 6 layers are exemplified.

In the present embodiment, the power mechanism 126 rotates the stirring shaft 122. For example, the power mechanism 126 includes a power portion (not illustrated) that generates power and a power transmission portion (not illustrated) that transmits power generated by the power portion to the stirring shaft 122. As the power portion, an electric motor is exemplified. As the power transmission portion, a reduction gear is exemplified.

The number of rotations of the stirring shaft 122, as well as the shape, the size, the quantity of blades, the installation position, the installation quantity, and an installation interval Pi of the stirring blade 124 are determined as appropriate according to an application of the polymerization apparatus 100. The number of rotations of the stirring shaft 122 and the shape, size, blade quantity, installation position, installation quantity, and installation interval of the stirring blade 124 are determined in consideration of, for example, the inner capacity of the reaction vessel 110, the shape of the reaction vessel 110, the internal structure arranged inside the reaction vessel 110, the configuration of the heat removal means, heat removal capability, and the constitution of the raw material charged for polymerization.

For example, if the polymerization apparatus 100 is used for the application of suspension polymerization, the number of rotations of the stirring shaft 122 is determined such that the stirring energy applied to the content (for example, the aqueous suspension mixture) is 80 to 200 kgf·m/s·m³. The “stirring energy” applied to the content is defined as net energy required for stirring per unit amount (may be referred to as unit internal capacity) of the content that is obtained by subtracting various types of energy loss B such as motor efficiency, conduction loss, mechanical loss or the like from energy A that is loaded on a stirrer drive motor arranged in the power mechanism 126, during operation of the polymerization apparatus 100. As the unit amount described above, unit mass, unit volume or the like are exemplified.

In the present embodiment, the baffle 130 improves the mixing performance of the polymerization apparatus 100. For example, the baffle 130 improves mixing performance of the vertical direction inside the reaction vessel 110. The installation position of the baffle 130 is not limited in particular, but for example, the baffle 130 is arranged near the inner wall of the reaction vessel 110. The baffle 130 may be supported by the side wall of the reaction vessel 110. In another embodiment, the baffle 130 is supported by a top plate or a bottom plate of the reaction vessel 110, and is arranged near the stirring blade 124. When the polymerization apparatus 100 is used for production of a polymer, the baffle 130 may be arranged so that an upper end of the baffle 130 is submerged in a liquid phase, and may be arranged so that the upper end of the baffle 130 is not submerged in the liquid phase.

The number of the baffles 130 is preferably approximately 1 to 12, preferably approximately 2 to 8, more preferably approximately 3 to 6, and further preferably approximately 4 to 6. It is preferable that an even number of the baffles 130 is arranged substantially symmetrically around an extending axis of the reaction vessel 110 (may be referred to as a central axis). Thus, the mixing performance of the polymerization apparatus 100 is further improved, and the stagnation of liquid is suppressed. As a result, the generation of scale can be suppressed.

In the present embodiment, the body 132 of the baffle 130 improves the mixing performance of the polymerization apparatus 100. The shape of the body 132 is not limited in particular, but for example, the body 132 has a plate-like or cylindrical shape extending substantially parallel to the extending direction of the reaction vessel 110. When the body 132 has a cylindrical shape, the diameter of the body 132 may be 40 to 500 mm.

The length of the body 132 (sometimes referred to as the height of the body 132) in the extending direction (z-direction in the figure) is not particularly limited. The length of the body 132 (sometimes referred to as the width of the body 132) in the direction (in the figure, x-direction or y-direction) substantially perpendicular to the extending direction is not particularly limited. The ratio of the width of the body 132 to the inner diameter of the reaction vessel 110 may be 1 to 10%, may be 2.5 to 7.5%, or may be 3 to 7%.

When the body 132 has a cylindrical shape, a proportion of a total value of areas of transverse sections of one or more bodies 132 each having a cylindrical shape, in relation to an area of a transverse section of the straight body portion of the reaction vessel 110 may be 0.4 to 3%. When the proportion described above is less than 0.4%, there is a possibility that the function as a baffle plate is insufficient, and mixing in the vertical direction inside the reaction vessel 110 becomes poor, for example, when the polymerization apparatus 100 includes a single baffle 130, the proportion described above can become less than 0.4%, for example, in suspension polymerization of a vinyl chloride-based monomer, when mixing in the vertical direction inside the reaction vessel 110 becomes insufficient, a particle size distribution of the produced polymer can become broad. As a result, when the produced polymer is molded into sheets, for example, there is a possibility that fish eyes increase and quality of the molded product decreases.

On the other hand, when the proportion described above exceeds 3%, the power requirement of the stirrer 120 increases excessively. In addition, the fluidity of the liquid between the baffle 130 and the inner surface 114 of the reaction vessel 110 may decrease. As a result, there is a possibility that scale tends to adhere to the reaction vessel 110 or a structure inside the reaction vessel 110, for example, when the polymerization apparatus 100 includes more than eight baffles 130, the proportion described above can exceed 3% depending on a design of the polymerization apparatus 100.

The body 132 of at least one baffle 130 may include a flow channel for circulation of a heat medium. The flow channel described above may be formed inside the body 132 and may be arranged outside the body 132. The flow channel described above may be a single-layer pipe and may have a double-pipe structure.

The heat medium may be a well-known coolant. As the coolant, water, brine, freon, another liquefied gas or the like are exemplified. If a liquefied gas is used as a coolant, the liquefied gas may function as the coolant by evaporating inside the cooling tube 140. The linear speed of the coolant may be approximately 0.1 to 6.0 m/s.

The body 132 is connected to the reaction vessel 110 via the support 134, for example. A distance between the body 132 and the inner wall surface of the polymerization apparatus 100 is preferably 40 mm or more. If the distance described above is less than 40 mm, the scale of the polymer may easily adhere between the inner surface 114 of the reaction vessel 110 and the baffle 130 near the gas-liquid interface inside the reaction vessel 110.

In the present embodiment, the support 134 holds the body 132. For example, one end of the support 134 contacts the inner surface 114 of the reaction vessel 110, and the other end of the support 134 contacts the body 132. As described above, the support 134 may retain the body 132 such that the distance between the body 132 and the inner surface 114 of the reaction vessel 110 is 40 mm or more.

In the present embodiment, the cooling tube 140 includes a flow channel therein for the circulation of heat medium. The heat medium may be a well-known coolant. Examples of the coolant include water, brine, freon, another liquefied gas or the like. If a liquefied gas is used as a coolant, the liquefied gas may function as the coolant by evaporating inside the cooling tube 140. The linear speed of the coolant may be approximately 0.1 to 6.0 m/s.

The shape and arrangement of the cooling tube 140 are not particularly limited. Examples of the cooling tube 140 include a ring pipe having a structure in which a plurality of ring-shaped pipes are in communication, a spiral pipe that extends in a spiral manner, a meandering pipe that extends by meandering, or the like.

In the present embodiment, the jacket 170 heats and cools the reaction vessel 110 from outside the reaction vessel 110. As described above, the jacket 170 includes the flow channel 172 that is configured to allow circulation of a heat medium. The jacket 170 adjusts heating amount and heat removal amount to and from the reaction vessel 110 by controlling at least one of a temperature or a volumetric flow rate of the heat medium flowing through the flow channel 172.

The heat medium may be a well-known coolant. As the coolant, water, brine, freon, various liquefied gas or the like are exemplified. As the coolant, a liquid coolant is preferably used. If a liquefied gas is used as a coolant, the liquefied gas may function as the coolant by evaporating inside the cooling tube 140. The linear speed of the coolant may be approximately 0.1 to 6.0 m/s.

In the present embodiment, the reflux condenser 180 is used for heat removal of the reaction vessel 110. The reflux condenser 180 is attached to the outside of the reaction vessel 110. The reflux condenser 180 condenses a part of the monomers that evaporate from the solution stored in the reaction vessel 110 during the polymerization reaction of the monomers.

For example, to the reflux condenser 180, steam is supplied from the reaction vessel 110. The reflux condenser 180 cools and liquefies the steam described above. The reflux condenser 180 returns the liquid generated by the cooling described above to the reaction vessel 110. As described above, the reflux condenser 180 includes the flow channel 182 that is configured to allow circulation of a heat medium. The reflux condenser 180 cools the steam from the reaction vessel 110 by heat exchange between the heat medium circulating through the flow channel 182, and the steam from the reaction vessel 110. The heat removal amount from the reaction vessel 110 can be adjusted by controlling at least one of a temperature or a volumetric flow rate of the heat medium flowing through the flow channel 182.

In the present embodiment, the coating apparatus 190 introduces the coating liquid described above into the reaction vessel 110. In this way, at least part of the inner surface 114 of the body 112 is coated with the coating liquid described above to form the scale prevention layer 116. The coating apparatus 190 is described below in detail.

### (I. Overview of the Composition Used to Form the Scale Prevention Layer 116)

In the present embodiment, the composition described above includes, for example, (i) the addition condensation product of the aromatic compound and the carbonyl compound and (ii) the thiol compound. The composition described above may include (i) an addition condensation product of an aromatic compound and a carbonyl compound, (ii) a thiol compound, and (iii) at least one of a solvent, a surfactant, or a pH adjusting agent.

The composition includes the thiol compound to suppress the condensation and/or sedimentation of the addition condensation product described above in the production process of the composition. As a result, the flexibility to adjust the composition and/or the coating liquid improves. In addition, for example, even if the composition and/or the coating liquid are heated with steam, the degradation of the addition condensation product included in the composition and/or the coating liquid may be suppressed.

The composition may include a mixture of isomers of an addition condensation product of an aromatic compound and a carbonyl compound. The composition includes, for example, a linear condensation product of an aromatic compound and a carbonyl compound and a cyclic condensation product of an aromatic compound and a carbonyl compound.

In the composition described above, the aromatic compound is, for example, naphthols. The aromatic compound may be at least one selected from the group consisting of 1-naphthol, 2-naphthol, and the derivatives thereof. The aromatic compound may be 1-naphthol, 2-naphthol, or the derivatives thereof.

The derivatives of 1-naphthol or 2-naphthol may be compounds in which at least one of the hydrogen atoms bonded to an aromatic ring of 1-naphthol or 2-naphthol is replaced by an alkyl group with a carbon number of 1 to 20, an alkoxy group with a carbon number of 1 to 20, an aminoalkyl group (also sometimes referred to as an alkylamino group) with a carbon number of 1 to 20, an amino group, and/or a thiol group. The thiol group described above may be a thiol group (for example, an alkanethiol group) with a carbon number of 1 to 20. 1-naphthol, 2-naphthol, and the derivatives described above are similar in their reactivity to a carbonyl compound. Therefore, the addition condensation products of 1-naphthol, 2-naphthol, or the derivatives described above and a carbonyl compound may be also similar in their degrading behaviors in steam.

In the composition described above, the carbonyl compound is, for example, an aldehyde compound or a ketone compound. The carbonyl compound may be an aldehyde compound or a ketone compound with a carbon number of 1 to 20. The carbonyl compound may be formaldehyde, acetaldehyde, terephthalaldehyde, benzaldehyde, or the derivatives thereof (sometimes referred to as the derivatives of a particular aldehyde compound). The ketone compound may be acetone, methyl ethyl ketone, acetylacetone, or the derivatives thereof (sometimes referred to as the derivatives of a particular ketone compound).

The derivatives of a particular aldehyde compound may be compounds in which at least one of the hydrogen atoms included in the particular aldehyde compound is replaced by an alkyl group with a carbon number of 1 to 20, an alkoxy group with a carbon number of 1 to 20, and an aminoalkyl group (also sometimes referred to as an alkylamino group) with a carbon number of 1 to 20, an amino group, and/or a thiol group. The thiol group described above may be a thiol group (for example, an alkanethiol group) with a carbon number of 1 to 20.

The derivatives of a particular ketone compound may be compounds in which at least one of the hydrogen atoms included in the particular ketone compound is replaced by an alkyl group with a carbon number of 1 to 20, an alkoxy group with a carbon number of 1 to 20, and an aminoalkyl group (also sometimes referred to as an alkylamino group) with a carbon number of 1 to 20, an amino group, and/or a thiol group. The thiol group described above may be a thiol group (for example, an alkanethiol group) with a carbon number of 1 to 20. A particular aldehyde compound, a particular ketone compound, and the derivatives thereof are similar in their reactivity to an aromatic compound. Therefore, the addition condensation products of the particular aldehyde compound, the particular ketone compound, or the derivatives described above, and an aromatic compound may also be similar in their degrading behaviors in steam.

In the compositions described above, the thiol compound includes, for example, a thiol group and at least one functional group selected from a group consisting of a hydroxyl group, an amino group, and a carboxyl group. The thiol compound may be at least one selected from a group consisting of thioglycerol, thioglycol, and the derivatives thereof. The thiol compound may be 1-thioglycerol or thioglycol. In one embodiment, the thiol compound may not be a thiourea tautomer.

The derivatives of 1-thioglycerol or thioglycol may be compounds in which at least one of the hydrogen atoms included in 1-thioglycerol or thioglycol is replaced by an alkyl group with a carbon number of 1 to 20, an alkoxy group with a carbon number of 1 to 20, an amino group, and/or an aminoalkyl group (sometimes referred to as an alkylamino group) with a carbon number of 1 to 20. The derivatives described above are expected to suppress the degradation of the addition condensation product described above to the same extent as 1-thioglycerol or thioglycol.

In one embodiment, the composition described above includes, for example, 0.01 parts by mass or more and 100 parts by mass or less of the thiol compound per 100 parts by mass of the aromatic compound. In this way, the condensation and/or sedimentation of the addition condensation product described above in the production process of the composition may be sufficiently suppressed. As a result, the flexibility to adjust the composition and/or the coating liquid further improves. In addition, even if the composition and/or the coating liquid are heated with steam, the degradation of the addition condensation product included in the composition and/or the coating liquid may be further suppressed.

In another embodiment, the composition described above includes, for example, a first type of addition condensation product (sometimes referred to as a first condensation product) and a second type of addition condensation product (sometimes referred to as a second condensation product). In the present embodiment, the first condensation product has a first average molecular weight. The second condensation product has a second average molecular weight. In the present embodiment, each of the first condensation product and the second condensation product is an addition condensation product of an aromatic compound and a carbonyl compound. In addition, the first average molecular weight is different from the second average molecular weight. The second average molecular weight may be greater than the first average molecular weight.

For example, if the second average molecular weight is greater than the first average molecular weight, in the composition described above, the ratio of the mass of the second condensation product to the mass of the first condensation product (sometimes referred to as a mass ratio or content ratio of the second condensation product to the first condensation product) may be 2.3 to 1000. The content ratio described above is preferably 2.3 to 100 and more preferably 2.3 to 10. The content ratio described above may also be 2.7 to 1000, may also be 2.7 to 100, or may also be 2.7 to 10. As described above, the content ratio described above is obtained by, for example, dividing the mass of the second condensation product included in the composition described above by the mass of the first condensation product included in the composition.

Since the content ratio described above in the composition described above is 2.3 or more, the content ratio described above in the coating film obtained by the coating with the composition in a steam coating method is relatively high. Specifically, the content ratio described above in the coating film described above may be maintained to be, for example, 0.75 or more (preferably, for example, 0.8 or more). When the content ratio described above in the coating film is high, the strength of the coating film improves. As a result, for example, when the polymer is produced by using a reactor or a polymerization vessel having the coating film described above, the scale adhesion prevention performance may be maintained until the completion of polymerization.

The content ratio described above in the composition described above is 1000 or less, so that the strength of the coating film obtained by the coating with the composition in a steam coating method may be adjusted appropriately. If the strength of the coating film described above is too high, when the polymer is produced by using the reactor or the polymerization vessel having the coating film described above, a relatively large amount of coating film remains on the inner surface of the reactor or the polymerization vessel at the end of the polymerization in each batch. Therefore, as the number of batches increases, the amount or thickness of the coating film accumulating on the inner surface of the reactor or polymerization vessel increases. As a result, the heat removal efficiency of the reactor or the polymerization vessel decreases.

When the strength of the coating film described above is not adjusted appropriately, the heat removal efficiency of the reactor or the polymerization vessel decreases significantly even if the repeat count of the polymerization process is less than 100 batches, for example. In contrast, when the content ratio described above in the composition described above is 1000 or less, the strength of the coating film is adjusted appropriately and the decrease in the heat removal efficiency of the reactor or the polymerization vessel is suppressed. As a result, when the content ratio described above is 1000 or less, a continuous operation with, for example, 100 batches or more can be achieved. When the content ratio described above is 100 or less, a continuous operation with, for example, 500 batches or more can be achieved. When the content ratio described above is 10 or less, a continuous operation with, for example, 1000 batches or more can be achieved.

For example, the first addition condensation product is a cyclic condensation product of an aromatic compound and a carbonyl compound, and the second addition condensation product is a linear condensation product of an aromatic compound and a carbonyl compound. In this case, the second average molecular weight may be greater than the first average molecular weight. The composition described above includes the linear condensation product with a relatively large average molecular weight and a cyclic condensation product with a relatively small average molecular weight, so that the strength of the coating film derived from the composition (sometimes referred to as a scale adhesion prevention layer) improves when the composition is used as a scale adhesion prevention agent, for example. As a result, for example, when the polymer is produced by using a reactor or a polymerization vessel having the coating film described above, the scale adhesion prevention performance may be maintained until the completion of polymerization.

The ratio of the mass of the second condensation product to the mass of the first condensation product in the composition or the coating film described above is derived from the area ratio of two peaks among a plurality of peaks obtained by, for example, analyzing the composition described above by the liquid chromatography analysis method (sometimes referred to as the LC method). As the LC method, the high performance liquid chromatography analysis method (sometimes referred to as the HPLC method) may be used.

When the composition described above includes two or more types of components with different average molecular weights, through the analysis of the composition with the LC method, a plurality of peaks are observed, including a peak corresponding to a component with a relatively low molecular mass (sometimes referred to as a low molecular mass object) and a peak corresponding to a component of a relatively high molecular mass (sometimes referred to as a high molecular mass object). The area of each peak is proportional to the content (for example, mass %) of the component corresponding to each peak in the composition described above.

In the LC method, the position of each peak may be identified from, for example, the retention factor of the component corresponding to each peak. The retention factor k of a particular component is derived from formula 1 described below by using the holdup time t_{O} and the retention time t_{R} of the particular component.

$$k = ( {t}_{R} - {t}_{O} ) / {t}_{O} \qquad ( formula 1 )$$

When the retention times of each of two types of compounds with molecular mass different from each other are compared, the retention factors of the two types of compounds are often different. Similarly, the retention factor of a compound with a high molecular mass is often higher than the retention factor of a compound with a low molecular mass.

It is noted that the composition described above may include three or more types of addition condensation products with average molecular weights different from each other. Each of the three or more types of addition condensation products described above may be an addition condensation product of an aromatic compound and a carbonyl compound.

According to the present embodiment, the composition having various properties may be adjusted by, for example, adjusting the added amount of at least one a thiol compound, a surfactant, or a pH adjusting agent. In this way, even if the composition and/or the coating liquid are heated with steam, the degradation of the addition condensation product included in the composition and/or the coating liquid may be sufficiently suppressed.

### (The Detail of the Analytic Procedure Through the LC Method)

The analysis with the LC method described above is performed according to the procedure described below, for example. First, a chromatograph is prepared. The detail of the chromatograph is not particularly limited and the specific configuration of the chromatograph is appropriately selected depending on the addition condensation product to be analyzed.

As the chromatograph, for example, Nexera/Prominence, which is a general purpose HPLC from SHIMADZU CORPORATION, is used. As the system controller of the chromatograph described above, for example, SCL-40 (from SHIMADZU CORPORATION) is used. As the liquid feeding unit of the chromatograph described above, for example, two units of LC-40D (from SHIMADZU CORPORATION) are used. As the online deaerator of the chromatograph described above, for example, DGU-403 (from SHIMADZU CORPORATION) is used. As the autosampler of the chromatograph described above, for example, SIL-20ACHT (from SHIMADZU CORPORATION) is used. As the column oven of the chromatograph described above, for example, CTO-20A (from SHIMADZU CORPORATION) is used. As the UV-VIS detector of the chromatograph described above, for example, SPD-20A (from SHIMADZU CORPORATION) is used.

The guard column and the analysis column are then prepared. The detail of the guard column and the analysis column are not particularly limited and the specific configurations of the guard column and the analysis column are selected appropriately depending on the addition condensation product to be analyzed.

As the guard column, for example, Puresil (registered trademark) C18 guard column (100 Å, 5 μm, 3.9 mm×20 mm×1 column) from Waters is used. As the analysis column, for example, μ-Bondasphere/DeltaPak (registered trademark) C18 column (100 Å, 5 μm, 3.9 mm×150 mm×1) from Waters is used.

Then, an eluent is prepared. In the present embodiment, two types of eluents are prepared. Specifically, for example, a solution in which 2 mL of acetic acid is added per 1 L of distilled water (sometimes referred to as eluent A) and a solution in which 1 mL of acetic acid is added per 1 L of acetonitrile (sometimes referred to as eluent B) are adjusted.

### (Measurement of Holdup Time t_{O})

Then, according to the procedure described below, the holdup time t_{O}, indicating the time for which non-retained substances pass through the column, is measured. First, as the sample for the measurement of the holdup time, an uracil aqueous solution is prepared. Specifically, first, 10 g of distilled water and 1 mg of uracil are mixed. Then, the mix solution described above is filtered by using a polytetrafluoroethylene filter with a pore diameter of 0.45 μm. In this way, the uracil aqueous solution is obtained.

Then, the uracil aqueous solution that has undergone the filtering process is set on the chromatograph described above and the measurement of the holdup time starts. In this case, the temperature of the column oven is set to, for example, 40° C. The detected wavelength of the UV-VIS detector is set to, for example, 288 nm. The injection amount of the uracil aqueous solution to be analyzed is set to, for example, 20 μL. The total value of the flow rate of the eluent A and the eluent B is set to, for example, 1.0 mL/min.

As the gradient condition of the eluent, first, the proportion of the eluent B relative to the total amount of eluent is set to 40% by volume. Then, the proportion of the eluent B relative to the total amount of eluent is linearly changed from 40% by volume to 100% by volume in 30 minutes. Subsequently, the proportion of the eluent B relative to the total amount of eluent is kept to be 100% by volume for 10 minutes.

After the measurement of the holdup time is started, the time until the peak is observed for the first time is measured. The retention time of the peak observed for the first time described above refers to the holdup time t_{O}.

### (Preparation of the Sample Including Addition Condensation Product)

Then, a sample including an addition condensation product of an aromatic compound and a carbonyl compound is prepared. In one embodiment, the composition described above is used as the sample described above. The composition described above may be produced or the composition may be purchased. In this way, the sample including the addition condensation product described above is prepared. In another embodiment, the sample described above is prepared by using the coating film formed of the composition described above. In this way, the sample including the addition condensation product is prepared. The coating film described above may be the coating film formed by steam coating.

The procedure for adjusting the sample described above by using the coating film described above is not particularly limited, but the sample described above is adjusted by using the coating film adhering to the inner surface 114 of the reaction vessel 110 through the procedure described below, for example. First, the sample of the coating film is obtained from the region inside the reaction vessel 110 to which the coating film adheres. Specifically, a swab impregnated with N-methyl-2-pyrrolidone (sometimes referred to as NMP) is rubbed on a square-shaped area with the range of 10 cm×10 cm included in the region described above. Because the addition condensation product included in the coating film dissolves in NMP, the swab described above retains the NMP solution including the addition condensation product. In this way, the sample of the coating film is obtained.

Then, 10.0 ml of NMP and 20 μL of 0.5 N hydrochloric acid are mixed. In this way, a solvent for collecting the NMP solution including the addition condensation product from the swab described above is prepared. Then, a 100 μL aliquot of the solvent described above is dripped onto the swab described above 10 times. In addition, the rinse liquid from the swab described above is collected. In this way, the sample including the addition condensation product is obtained.

### (Measurement of the Retention Time t_{R} for Each Component Included in the Sample Including Addition Condensation Product)

First, the sample including the addition condensation product described above is filtered by using the polytetrafluoroethylene filter with a pore diameter of 0.45 μm. Then, the sample that has undergone the filtering process (in other words, the filtrate obtained through the filtering process) is set on the chromatograph described above and the measurement of the retention time is started.

The measurement condition of the retention time t_{R} may be the same as the measurement condition of the holdup time t_{O} described above. Specifically, the temperature of the column oven is set to, for example, 40° C. The detected wavelength of the UV-VIS detector is set to, for example, 288 nm. The injection amount of the sample to be analyzed is set to, for example, 20 μL. The total value of the flow rate of the eluent A and the eluent B described above is set to, for example, 1.0 mL/min.

As the gradient condition of the eluent, first, the proportion of the eluent B relative to the total amount of eluent is set to 40% by volume. Then, the proportion of the eluent B relative to the total amount of eluent is linearly changed from 40% by volume to 100% by volume in 30 minutes. Subsequently, the proportion of the eluent B relative to the total amount of eluent is kept to be 100% by volume for 10 minutes.

### (Deriving the Content Ratio of the Second Condensation Product to the First Condensation Product)

As described above, the composition described above may include two or more types of addition condensation products. Each of the two or more types of addition condensation products described above is an addition condensation product of an aromatic compound and a carbonyl compound and has an average molecular weight different from each other.

The content proportion (sometimes referred to as content) of each addition condensation product in the composition may be derived based on, for example, the areas of one or more peaks (sometimes referred to as a peak area) that appear on the measurement result of the LC method (sometimes referred to as a chromatogram). The content proportion described above is, for example, % by mass. As described above, in the LC method, the position of each peak is identified with the retention factor of the component corresponding to each peak.

For example, if the composition described above includes at least a first condensation product having a first average molecular weight and a second condensation product having a second average molecular weight, the content proportion of the first condensation product in the composition is, for example, proportional to the total value of the areas of each of one or more peaks that appear between the first retention factor k1 and the second retention factor k2 in the chromatogram. The total value described above may be derived as the content proportion of the first condensation product described above.

Similarly, the content proportion of the second condensation product in the composition is proportional to, for example, the total value of the areas of each of one or more peaks that appear between the third retention factor k3 and the fourth retention factor k4 in the chromatogram. The total value described above may be derived as the content proportion of the second condensation product described above.

The first retention factor k1 may be lower than the second retention factor k2. The second retention factor k2 may be lower than the third retention factor k3. The third retention factor k3 may be lower than the fourth retention factor k4. The first retention factor k1 may be 0 or more. The fourth retention factor k4 may be more than 0 and 25 or less.

For example, when the combination of an aromatic compound and a carbonyl compound constituting the first condensation product is the same as the combination of an aromatic compound and a carbonyl compound constituting the second condensation product, the first retention factor k1 may be a retention factor corresponding to the first peak of the aromatic compound dimer generated as a result of the reaction of the aromatic compound and the carbonyl compound with a molar ratio of 2:1. The second retention factor k2 may be the retention factor corresponding to the last peak of the cyclic tetramer of the aromatic compound generated as a result of the reaction of the aromatic compound and the carbonyl compound with a molar ratio of 4:4. The third retention factor k3 may be the retention factor corresponding to the peak that appears next to the peak corresponding to the second retention factor k2 described above. The fourth retention factor k4 may be 25.

For example, when the aromatic compound described above is α-naphthol and the carbonyl compound described above is formaldehyde, the first retention factor k1 may be 7 or more and the second retention factor k1 may be less than 16. In addition, the third retention factor k3 may be 16 or more and the fourth retention factor k4 may be 25 or less.

In this case, the content proportion of the first condensation product in the composition is proportional to the total value of the areas of each of one or more peaks that appear between a retention factor of 7 or more and less than 16. Similarly, the content proportion of the second condensation product in the composition is proportional to the total value of areas of each of one or more peaks that appear between the retention factor of 16 or more and 25 or less.

As described above, in the composition described above, the content ratio of the second condensation product to the first condensation product is obtained by dividing the mass of the second condensation product included in the composition by the mass of the first condensation product included in the composition. The content ratio described above may be derived as a ratio of the content proportion of the second condensation product in the composition to the content proportion of the first condensation product in the composition. It is noted that the content ratio described above in the coating film may be derived according to a procedure similar to that of the content ratio described above in the composition.

According to the composition of the present embodiment, since the content ratio described above falls in the numeric range described above, the coating film produced by using the composition includes a lot of addition condensation products with a relatively high molecular mass. In this way, during a period in which the polymerization reaction proceeds inside the reaction vessel, the scraping of the coating film by the polymerization slurry is suppressed. As a result, for example, the scale adhesion prevention performance may be maintained until the completion of polymerization.

### (The Effect of Steam Exposure on the Content Ratio)

As described above, depending on the constitution of the scale adhesion prevention agent, when the scale adhesion prevention agent is introduced into the reaction vessel by using steam, the active ingredient of the scale adhesion prevention agent undergoes thermal decomposition and, as a result, may become difficult to be used as a scale adhesion prevention agent. In contrast, since the composition according to the present embodiment includes a thiol compound, for example, the thermal decomposition or the like of the second condensation product with a relatively large average molecular weight may be suppressed even if the composition is exposed to the steam under a particular condition. As a result, the decrease in the content ratio of the second condensation product to the first condensation product described above may be suppressed.

According to the present embodiment, since the decrease in the content ratio described above is suppressed, the coating film includes a lot of addition condensation products with a relatively high molecular mass, even if the coating film is produced by a steam coating method, for example. In this way, during a period in which the polymerization reaction proceeds inside the reaction vessel, the scraping of the coating film by the polymerization slurry is suppressed. As a result, the scale adhesion prevention performance may be maintained until the completion of polymerization.

According to the present embodiment, the content ratio of the second condensation product to the first condensation product in the composition exposed to steam under a particular condition is, for example, 0.75 to 1000. The content ratio described above may be 0.75 to 100 or may be 0.75 to 10. The content ratio described above may be 0.8 to 1000, may be 0.8 to 100, or may be 0.8 to 10.

In one embodiment, the particular condition described above may be the condition that the composition is exposed to the steam of 0.717 MPaG (171.4° C.) for 120 seconds. In another embodiment, the particular condition described above may also be the condition that the composition described above is flowed, with a flow rate of 10.8 kg/h, into the cylindrical-shaped reactor with an internal volume of 2 m³ for 120 seconds by using the steam of 240 kg/h and 0.717 MPaG (171.4° C.) as a carrier.

### (II. The Constitution of Composition)

### (A. Addition Condensation Product)

As described above, the composition includes an addition condensation product of an aromatic compound and a carbonyl compound. The composition described above (i) may include a linear condensation product of an aromatic compound and a carbonyl compound, (ii) may include a cyclic condensation product of an aromatic compound and a carbonyl compound, or (iii) may be a mixture of the linear condensation product and the cyclic condensation product. The addition condensation product may exist as salt in the composition. As described above, in the present embodiment, the term “addition condensation product” means the addition condensation product and/or the salt of the addition condensation product.

The addition condensation product described above may be an aromatic compound polymer in which each of two or more building blocks derived from the aromatic compound connects to each other via one building block derived from a carbonyl compound. Specifically, the aromatic compound has a portion constituting a building block (A) derived from an aromatic compound in an addition condensation product. In addition, the carbonyl compound includes a portion constituting a building block (B) derived from a carbonyl compound in an addition condensation product. The aromatic compound dimer is a compound having a structure of A-B-A, for example. The aromatic compound polymer is a compound having a structure in which A and B are alternated, that is, A-B-A . . . B-A, for example.

The addition condensation product may be obtained by, for example, causing an aromatic compound and a carbonyl compound to react in the presence of a catalyst and a surfactant. The addition condensation product is obtained by, for example, (i) preparing a mixture of a reaction solvent, an aromatic compound, a carbonyl compound, and a thiol compound and (ii) causing the aromatic compound and the carbonyl compound in the mixture to react in the presence of the catalyst and the surfactant.

### (Aromatic Compound)

Examples of the aromatic compounds include a benzene derivative, a naphthalene derivative, a polynuclear aromatic compound, a non-benzene aromatic compound, or the like. The aromatic compound may be a compound that is selected from a group consisting of a benzene derivative, a naphthalene derivative, a polynuclear aromatic compound, and a non-benzene aromatic compound and includes 3 to 20 conjugated n bonds. A single type of aromatic compound may be used or two or more types of aromatic compounds may be used together.

Examples of benzene derivatives include (i) phenols and derivatives thereof, (ii) aromatic amines and derivatives thereof, (iii) nitro and nitroso derivatives, (iv) aromatic aldehyde, (v) a benzene derivative further including one type of substituent group other than an aldehyde group, (vi) a benzene derivative further including one type of substituent group other than an acyl group, (vii) a derivative of benzene or toluene including three or more types of different substituent groups, (viii) aralkyl compound, and (ix) at least one type of compound selected from a group consisting of a diazo compound and an azo compound. Examples of phenols and derivatives thereof include phenol, 2-methylphenol, 3-methylphenol, 4-methylphenol, 3,5-dimethylphenol or the like. Examples of aromatic amines and derivatives thereof include pyridine, quinoline, carbazole, o-phenanthroline, p-phenanthroline, 3,6-diaminoacridine, 3-aminophenothiazine, 2-aminophenazine, phenothiazine, 2-hydroxy-4-methylquinoline or the like. Examples of nitro and nitroso derivatives include nitrobenzene, phenazine, phenazine oxide, 1-phenylazo-2-naphthol, trifluorodioxazine, 4-nitroxane, or the like. Examples of aromatic aldehyde include benzaldehyde, benzoflavin, or the like. Examples of benzene derivatives further including one type of substituent group other than an aldehyde group include 1-hydroxy-2,4-methylfluorone, 3-phenylcoumarone, coumarin-3-carboxylic acid ethyl ester, 3-acetylcoumarin, 5-chloro-3-(4-hydroxyphenyl) anthranil, 3-nitroacridone, or the like. Examples of benzene derivatives further including one type of substituent group other than an acyl group include xanthone, 2-benzoylxanthone, xanthene, fluorene, or the like. Examples of derivatives of benzene or toluene including three or more types of different substituent groups include 7-acetoxy-8-methoxy-3-(2-nitrophenyl) carbostyril or the like. Examples of aralkyl compound include 9-benzyl acridine. Examples of a diazo compound and azo compound include 1,1′-azonaphthalene, azoxyphenol, or the like.

Examples of naphthalene derivative include (i) alkyl, alkenyl, and phenylnaphthalenes, (ii) dinaphthyls, (iii) naphthylarylmethanes, (iv) naphthyl arylethanes, (v) hydronaphthalenes, (vi) nitronaphthalene and derivatives thereof, (vii) halogenated naphthalenes, (viii) naphthylhydroxylamine, naphthylpyrazine, and naphthylureas, (ix) naphthalene-based aralkyl compound, (x) naphthaldehydes and derivatives thereof, (xi) acetonaphthene and benzoylnaphthalenes, and (xii) at least one type of compound selected from a group consisting of naphthols. Examples of alkyl, alkenyl, and phenylnaphthalenes include 2-methylnaphthalene, 1-ethylnaphthalene, 2-ethylnaphthalene, 1,2-dimethylnaphthalene, or the like. Examples of dinaphthyls include 1,1′-dinaphthyl, 1,2′-dinaphthyl, 2,2′-dinaphthyl, or the like. Examples of naphthylarylmethanes include 1-benzylnaphthalene, 2-benzylnaphthalene, 1-(α, α-dichlorobenzyl) naphthalene, diphenyl-α-naphthylmethane, diphenyl-β-naphthylmethane, di-α-naphthylmethane, or the like. Examples of naphthyl arylethanes include 1,2-di-α-naphthylethan, 1,2-di-β-naphthylethan, or the like. Examples of hydronaphthalenes include 1,2-dihydronaphthalene, 1,4-dihydronaphthalene, 1,2,3,4-tetrahydronaphthalene or the like. Examples of nitronaphthalene and derivatives thereof include nitromethylnaphthalene, nitroalkylnaphthalene, nitrophenylnaphthalene, halonitronaphthalene, halodinitronaphthalene, nitrosonaphthalene, diaminonaphthalene, triaminonaphthalene, tetraaminonaphthalene, or the like. Examples of halogenated naphthalenes include 1-fluoronaphthalene, 1-chlornaphthalene, 1-chlor-3,4-dihydronaphthalene, or the like. Examples of naphthylhydroxylamine, naphthylpyrazine, and naphthylureas include α-naphthylhydroxylamine, β-naphthylthiohydroxylamine, N-nitroso-α-naphthylhydroxylamine, α-naphthylhydrazine, 1,2-dibenzocarbazole, or the like. Examples of naphthalene-based aralkyl compound include dibenzoanthracene, acenaphthene, diphenylnaphthylchloromethane, nitromethylnaphthalene, or the like. Examples of naphthaldehydes and derivatives thereof include α-naphthaldehyde, 2-(2,4-dinitrophenyl)-1-(α-naphthyl)ethylene, or the like. Examples of acetonaphthene and benzoylnaphthalenes include (1,2 or 5,6-)dibenzanthracene, 2′-methyl-2,1′-dinaphthyl ketone, 2-methyl-1,1′-dinaphthyl ketone, styryl-2-naphthyl ketone, or the like. Examples of naphthols include 1-naphthol (sometimes referred to as α-naphthol), 2-naphthol (sometimes referred to as β-naphthol), 1,3-dihydroxy-naphthalene, 1,5-dihydroxynaphthalene and 1,7-dihydroxynaphthalene, 6-hydroxy-2-naphthoic acid, 2-hydroxy-1-naphthoic acid, 1-hydroxy-2-naphthoic acid, 1-hydroxy-8-naphthoic acid, or the like.

Examples of polynuclear aromatic compounds include (i) anthracenes and derivatives thereof, (ii) phenanthrenes and derivatives thereof, and (iii) at least one type of compound selected from a group consisting of another polynuclear aromatic compound and derivatives thereof. Examples of anthracenes and derivatives thereof include anthracene, 1,2-dihydroanthracene, 1-chloroanthracene, 1,4-dichloroanthracene, 1-nitroanthracene, 9,10-dinitroanthracene, 1-aminoanthracene, 2-dimethylaminoanthracene, 2-anilinoanthracene, 9-methylaminoanthracene, 1,4-diaminoanthracene, or the like. Examples of phenanthrenes and derivatives thereof include phenanthrene, 9,10-dihydrophenanthrene, 1,2,3,4-tetrahydrophenanthrene, 1-chlorophenanthrene, or the like. Examples of another polynuclear aromatic compounds and derivatives thereof include, for example, pentacene, hexacene, benzophenanthrene, benzo[a]anthracene, pyrene, coronene, or the like.

Examples of non-benzene aromatic compounds include azulene, cyclodecapentane, cyclotetradecaheptane, cyclooctadecanonaene, cyclotetracosadodecane, heptalene, fulvalene, sesquifulvalene, heptafulvalene, perinaphthene, or the like. The non-benzene aromatic compound may be a derivative of the compound described above.

As an aromatic compound, naphthols may be used. In this way, an addition condensation product may be generated in a mild condition. As a result, the production cost of addition condensation product may be reduced. As an aromatic compound, the compound represented by the general formula (1) described below may be used.

(General Formula 1)

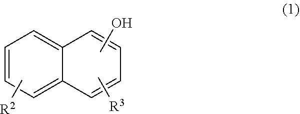

In the general formula (1), R² and R³ are each a hydrogen atom or a hydrocarbon group. Examples of hydrocarbon groups include a methyl group, an ethyl group, an n-propyl group, an isopropyl group, an n-butyl group, an isobutyl group, an n-octyl group, or the like.

In the general formula (1), the compounds in which R² and R³ are each a hydrogen atom or a hydrocarbon group and each hydrocarbon group is a methyl group, an ethyl group, an n-propyl group, an isopropyl group, an n-butyl group, an isobutyl group, or an n-octyl group are similar in their reactivity to a carbonyl compound. Therefore, the addition condensation product of an aromatic compound represented by the general formula (1) and a carbonyl compound may also be similar in their degrading behavior in steam.

As an aromatic compound, 1-naphthol, 2-naphthol, or derivatives thereof are preferably used. The derivatives of 1-naphthol or 2-naphthol may be compounds in which at least one of the hydrogen atoms bonded to an aromatic ring of 1-naphthol or 2-naphthol is replaced by an alkyl group with a carbon number of 1 to 20, an alkoxy group with a carbon number of 1 to 20, and an aminoalkyl group (also sometimes referred to as an alkylamino group) with a carbon number of 1 to 20, an amino group, and/or a thiol group. The thiol group described above may be a thiol group (for example, an alkanethiol group) with a carbon number of 1 to 20. The aromatic compound may be 1-naphthol.

### (Carbonyl Compound)

The detail of a carbonyl compound is not particularly limited as long as it is an organic compound having a carbonyl group. A single type of carbonyl compound may be used or two or more types of carbonyl compound may be used together. Examples of carbonyl compounds include aldehydes (sometimes referred to as an aldehyde compound), ketones (sometimes referred to as a ketone compound) or derivatives thereof, or the like. The carbonyl compound may be an aldehyde compound or a ketone compound with a carbon number of 1 to 20.

Examples of aldehydes include formaldehyde, acetaldehyde, terephthalaldehyde, or derivatives thereof or the like. The derivatives of an aldehyde compound described above may be compounds in which at least one of the hydrogen atoms included in the aldehyde compound is replaced by an alkyl group with a carbon number of 1 to 20, an alkoxy group with a carbon number of 1 to 20, and an aminoalkyl group (also sometimes referred to as an alkylamino group) with a carbon number of 1 to 20, an amino group, and/or a thiol group. The thiol group described above may be a thiol group (for example, an alkanethiol group) with a carbon number of 1 to 20. The carbon number of a substituent group may be adjusted such that the carbon number of the aldehyde compound is 1 to 20.

Examples of ketones include acetone, methyl ethyl ketone, acetylacetone, or derivatives thereof or the like. The derivatives of the ketone compound described above may be compounds in which at least one of the hydrogen atoms included in the ketone compound is replaced by an alkyl group with a carbon number of 1 to 20, an alkoxy group with a carbon number of 1 to 20, and an aminoalkyl group (also sometimes referred to as an alkylamino group) with a carbon number of 1 to 20, an amino group, and/or a thiol group. The thiol group described above may be a thiol group (for example, an alkanethiol group) with a carbon number of 1 to 20. The carbon number of a substituent group may be adjusted such that the carbon number of the aldehyde compound is 1 to 20.

As a carbonyl compound, an aldehyde compound represented by the general formula (2) described below may be used. In this way, the production cost of addition condensation product may be reduced.

R¹—CHO (General formula 2)

In the general formula (2) described above, R¹ is a hydrogen atom or a hydrocarbon group. The carbon number of the hydrocarbon group described above may be 1 to 20. The carbon number of the hydrocarbon group described above may be 1 to 19. Examples of hydrocarbon groups include a methyl group, an ethyl group, an n-propyl group, an isopropyl group, an n-butyl group, an isobutyl group, an n-octyl group, or the like.

In the general formula (2), the compounds in which R¹ is a hydrogen atom, a hydrocarbon group with a carbon number of 1 to 20, or a hydrocarbon group with a carbon number of 1 to 19 are similar in their reactivity to an aromatic compound. Therefore, the addition condensation products of an aromatic compound and an aldehyde compound represented by the general formula (2) may also be similar in their degrading behavior in steam.

As a carbonyl compound, formaldehyde and/or acetaldehyde may be used. The carbonyl compound may be formaldehyde.

### (A Specific Example Related to a Combination of an Aromatic Compound and a Carbonyl Compound)

In one embodiment, an aromatic compound is a compound represented by the general formula (1) described above and a carbonyl compound may be an aldehyde compound represented by the general formula (2) described above. In another embodiment, the aromatic compound may be 1-naphthol and the carbonyl compound may be formaldehyde.

### (B. Thiol Compound)

As described above, the composition includes a thiol compound. A single type of thiol compound may be used or two or more types of thiol compound may be used together.

The detail of a thiol compound is not particularly limited as long as it is an organic compound having a thiol group. The thiol compound includes, for example, a thiol group and at least one functional group selected from a group consisting of a hydroxyl group, an amino group, and a carboxyl group. The thiol compound preferably includes at least one hydroxyl group.

In this way, the thiol compound may obtain water solubility and detergency. The thiol compound may also exist as salt in the composition. As described above, in the present embodiment, the term “thiol compound” means the thiol compound and/or the salt of the thiol compound.

Examples of a thiol compound include alkyl mercaptans, aromatic mercaptans, thiocarboxylic acids, thiocarboxylic acid alkyl esters, nitrogen-containing thiols, and polythiols, and the mixture thereof. Examples of alkyl mercaptans include n-octyl mercaptan, n-dodecyl mercaptan, t-dodecyl mercaptan, n-tetradecyl mercaptan, n-octadecyl mercaptan, or the like. Examples of aromatic mercaptans include benzyl mercaptan, dodecylbenzyl mercaptan, p-chlorobenzyl mercaptan, or the like. Examples of thiocarboxylic acids include thioacetic acid, thiopropionic acid, thiobutyric acid, thiovaleric acid, thiolactic acid, 3-mercaptopropionic acid, thiosuccinic acid, thiobenzoic acid, or the like. Examples of thiocarboxylic acid alkyl esters include glycerol monothiolactate, ammonium thiolactate, MEA-thiolactate, glycerol 3-mercaptopropionate, ethylene glycol 3-mercaptopropionate, n-butyl mercaptopropionate, n-butyl thioglycolate, ethyl thioglycolate, isooctyl thioglycolate, dodecyl mercaptopropionate, octadecyl mercaptopropionate, tridecyl thioglycolate, or the like.

Examples of nitrogen-containing thiols include cysteamine, N-acetylcysteamine, N-propionylcysteamine, cysteine, N-acetylcysteine, N-alkanoylcysteine, cysteine alkyl esters, homocysteine, thioglycolic acid, ethanolamine thioglycolate, glyceryl thioglycolate, thiomalic acid, glutathione, α-thioglycerol (sometimes referred to as 1-thioglycerol, 3-mercapto-1,2-propanediol, or the like), thioglycol (sometimes referred to as β-mercaptoethanol, 2-mercaptoethanol, or the like), thiodiglycol, dithiothreitol, thioxanthine, thiosalicylic acid, thiopropionic acid, lipoic acid, monoethanolamine thioglycolate, 2-dimethylamineethanethiol hydrochloride, 2-dimethylaminoethanethiol hydrochloride, diaminopropanethiol hydrochloride, 2-mercaptoamine hydrochloride, or the like. Examples of polythiols include 2,2′-dimercaptodiethyl ether, dithio-terephthalic acid, glycol dimercaptoacetate, pentaerythritol tetrathioglycolate, trimethylolethane trithioglycolate, trimethylolpropane trithioglycolate, or the like.

As described above, the thiol compound may be at least one selected from a group consisting of thioglycerol, thioglycol, thiodiglycol, and derivatives thereof. The thiol compound may be at least one selected from a group consisting of thioglycerol, thioglycol, and the derivatives thereof. The derivatives of thioglycerol, thioglycol, or thiodiglycol may be compounds in which at least one of the hydrogen atoms included in thioglycerol, thioglycol, or thiodiglycol is replaced by an alkyl group with a carbon number of 1 to 20, an alkoxy group with a carbon number of 1 to 20, an amino group, and/or an aminoalkyl group (sometimes referred to as an alkylamino group) with a carbon number of 1 to 20.

The thiol compound may be 3-mercapto-1,2-propanediol, 2-mercaptoethanol, or derivatives thereof. The derivatives described above may be compounds in which at least one of the hydrogen atoms included in 3-mercapto-1,2-propanediol or 2-mercaptoethanol is replaced by an alkyl group with a carbon number of 1 to 20, an alkoxy group with a carbon number of 1 to 20, an amino group, and/or an aminoalkyl group (sometimes referred to as an alkylamino group) with a carbon number of 1 to 20. The thiol compound may be 3-mercapto-1,2-propanediol and/or 2-mercaptoethanol.

The composition includes, for example, 0.01 parts by mass or more and 100 parts by mass or less of a thiol compound per 100 parts by mass of an aromatic compound. The composition may include 0.1 parts by mass or more and 20 parts by mass or less of a thiol compound per 100 parts by mass of an aromatic compound, may include 0.1 parts by mass or more and 10 parts by mass or less of a thiol compound per 100 parts by mass of an aromatic compound, may include 0.5 parts by mass or more and 10 parts by mass or less of a thiol compound per 100 parts by mass of an aromatic compound, or may include 1 parts by mass or more and 5 parts by mass or less of a thiol compound per 100 parts by mass of an aromatic compound.

The content proportion of an aromatic compound in the composition is identified by, for example, using a mass spectrometer (sometimes referred to as MS) as a detector in the LC method described above (sometimes referred to as LC/MS method). Similarly, the content of a thiol compound in the composition is identified by, for example, the LC/MS method described above.

### (C. Solvent)

As described above, the composition may include a solvent (sometimes referred to as a reaction solvent). The detail of the solvent is not particularly limited as long as the solvent is a compound that is in the liquid state in a reaction condition for generating the addition condensation product described above. Examples of the reaction conditions described above include a reaction temperature, a reaction pressure, or the like. A single type of solvent may be used or two or more types of solvent may be used together.

Examples of reaction solvents include water or an organic solvent. Examples of organic solvents include alcohols, ketones, esters, amides, or the like. Examples of alcohols include methanol, ethanol, propanol, or the like. Examples of ketones include acetone, methyl ethyl ketone, or the like. Examples of esters include methyl acetate, ethyl acetate, or the like. Examples of amides include dimethylformamide, diethylformamide, dimethylacetamide, N-methylpyrrolidone, or the like.

The content of solvent in the composition is, for example, 95% by mass or less. In this way, the efficiency of the coating with the components of the composition other than the solvent may improve. The content of solvent in the composition may be 50% by mass or more and 95% by mass or less.

### (D. Surfactant)

As described above, the composition may include a surfactant. The surfactant is, for example, a compound including a hydrophilic group and a hydrophobic group (sometimes referred to as a surfactant compound). A single type of surfactant may be used or two or more types of surfactant may be used together. Examples of surfactants include a well-known compound used for the production of the addition condensation product described above, a well-known compound added to a scale adhesion prevention agent (for example, a scale adhesion prevention agent used for polymerization of polyvinyl chloride), or the like.

The composition includes, for example, 0.01 equivalents or more of a surfactant relative to an aromatic compound. The composition may include 0.1 equivalent or more and 5.0 equivalent or less of a surfactant or may include 0.5 equivalent or more and 2.0 equivalent or less of a surfactant relative to an aromatic compound. In this way, when the composition described above is used as a scale adhesion prevention agent, the stability of the aqueous solution of the composition improves.

The content of a surfactant in the composition is, for example, 0.01 equivalents or more relative to the structural unit derived from an aromatic compound included in an addition condensation product. The content of the surfactant in the composition may be 0.1 equivalents or more and 5.0 equivalents or less or may be 0.5 equivalents or more and 2.0 equivalents or less, relative to the structural unit derived from an aromatic compound included in an addition condensation product.

The surfactant is input to a reaction system together with a catalyst for a condensation reaction in the production process of an addition condensation product, for example. The surfactant is input to the reaction system such that 0.01 equivalents or more of the surfactant is added relative to the aromatic compound, for example. The surfactant may be input to the reaction system such that 0.1 equivalents or more and 5.0 equivalents or less of the surfactant is added relative to the aromatic compound. The surfactant may be input to the reaction system such that 0.5 equivalents or more and 2.0 equivalents or less of the surfactant is added relative to the aromatic compound.

In the present embodiment, the surfactant may be an anionic surfactant. The surfactant may include a pyrrolidone-based surfactant. The pyrrolidone-based surfactant includes, for example, pyrrolidones or derivatives thereof.

The surfactant may be a non-macromolecular compound. The non-macromolecular compound described above may be a compound with a weight-average molecular weight (polystyrene conversion value) less than 10000. The weight-average molecular weight described above is measured by, for example, a gel permeation chromatography (GPC) using tetrahydrofuran (THF). The non-macromolecular compound described above may be a polymer or condensation product in which the value obtained by multiplying the value represented by a degree of polymerization or a degree of condensation by the molecular mass of the monomer unit (sometimes referred to as an average molecular weight) is less than 10000.

Examples of the surfactants include polyvinyl alcohol, cellulose, ethyl cellulose, hydroxypropyl cellulose, hydroxyethyl cellulose, hydroxypropyl methylcellulose, sodium dodecyl sulfate, sodium dodecane sulfonate, ammonium lauryl sulfate, sodium cetyl sulfate, sodium myristyl sulfate, potassium lauryl sulfate, sodium phenyl phenol, sucrose, maltose, glucose, fructose, sorbitol, mannitol, xylitol, sodium benzoate, linear sodium dodecylbenzene sulfonate, branched sodium dodecylbenzene sulfonate, sodium dodecanoate, sodium octanoate, sodium butylnaphthalene sulfonate, sodium 1-naphthalenesulfonate, sodium hexadecane sulfonate, sodium octane sulfonate, ethanol, ethoxyethanol, t-butanol, propanol, methoxyethanol, glycerin, acetic acid, malic acid, salicylic acid, propionic acid, glutamic acid, aspartic acid, citric acid, ascorbic acid, ethylenediaminetetraacetic acid, histidine, ethanolamine, dextrin, lauryl betaine, niacinamide, triisopropanolamine, quaternium-22, quaternium-45, or the like. The surfactant may be at least one compound selected from a group consisting of sodium dodecyl sulfate, sodium hexadecane sulfonate, sodium dodecanoate, sodium butylnaphthalene sulfonate, sodium octane sulfonate, sodium 1-naphthalenesulfonate, propanol, ethanol, and 1-methoxyethanol.

### (E. Catalyst)

Examples of the catalysts include bronsted acid, lewis acid, base, or the like. Examples of bronsted acid include hydrochloric acid, sulfuric acid, phosphoric acid, citric acid, or the like. Examples of Lewis acids include aluminum chloride, monoborane, diborane, boron trifluoride, alumina, or the like. Examples of bases include ammonia, triethylamine, alkali metal hydroxide, or the like. Examples of alkali metal hydroxide include lithium hydroxide, sodium hydroxide, potassium hydroxide, or the like. As the catalyst, alkali metal hydroxide is preferably used.

### (F. Auxiliary Agent)

The composition including addition condensation product may also include various auxiliary agents. Examples of auxiliary agents include a reduction agent, a water-soluble macromolecule, a pH adjusting agent, and/or, other compounds. Examples of the other compounds include an inorganic colloid, an alkali metal silicate, an antioxidant, or the like. The auxiliary agent is added as needed provided that it does not impair the purpose and effect of the composition. The content of the auxiliary agent in the composition is adjusted to be, for example, 0% by mass or more and 50% by mass or less. The auxiliary agent may be added to the composition at any time in the production process of the composition.

### (Reduction Agent)

Examples of reduction agents include sulfite, phosphite, nitrite, reducing sugars, thiourea dioxide, or the like. A single type of reduction agent may be used or two or more types of reduction agents may be used together. As the reduction agent, sulfite and/or thiourea dioxide may be used.

Examples of sulfites include ammonium sulfite, potassium sulfite, sodium sulfite, ammonium hydrogen sulfite, sodium hydrogen sulfite, sodium dithionite (Na₂S₂O₄), rongalite, or the like.

Examples of phosphites include ammonium phosphite, sodium phosphite, potassium phosphite, calcium phosphite, uranyl phosphite, cobalt phosphite, ferrous phosphite, ferric phosphite, copper phosphite, barium phosphite, hydrazinium phosphite, ammonium hydrogen phosphite, sodium hydrogen phosphite, potassium hydrogen phosphite, potassium hydrogen phosphite, calcium hydrogen phosphite, cobalt hydrogen phosphite, cuprous hydrogen phosphite, cupric hydrogen phosphite, ferrous hydrogen phosphite, ferric hydrogen phosphite, lead hydrogen phosphite, barium hydrogen phosphite, magnesium hydrogen phosphite, manganese hydrogen phosphite, hydrazinium hydrogen phosphite, or the like.

Examples of nitrites include ammonium nitrite, sodium nitrite, potassium nitrite, calcium nitrite, zinc nitrite, silver nitrite, potassium cobalt nitrite, sodium cobalt nitrite, strontium nitrite, cesium nitrite, cerium nitrite, cupric nitrite, nickel nitrite, barium nitrite, magnesium nitrite, lithium nitrite, rubidium nitrite, or the like.

The reducing sugars refer to sugars that include a free aldehyde group or carbonyl group and exhibit reducibility. Examples of reducing sugars include maltose, lactose, grape sugar (glucose), or the like.

The content of the reduction agent in the composition may be 0.01 to 10 parts by mass per 100 parts by mass of the addition condensation product. The content of the reduction agent in the composition is preferably about 0.1 to 3 parts by mass per 100 parts by mass of the addition condensation product.

The reduction agent is added to the composition to improve the stability in uniformity of the composition including the products of a condensation reaction obtained through a condensation reaction. In addition, the reduction agent is added to the composition to suppress the generation of a gelled substance in the composition. In this way, the shelf life of the composition becomes longer. In addition, the gelled substance may be prevented beforehand from contaminating a polymer product. Furthermore, the reduction agent may be added to the composition to improve the scale adhesion prevention effect of the scale prevention layer 116 formed of the composition (sometimes simply referred to as a coating film of the composition).

(Water-soluble macromolecule)

Examples of water-soluble macromolecules include an anionic macromolecular compound, an amphoteric macromolecular compound, a cationic macromolecular compound, a nonionic macromolecular compound, a hydroxyl group-containing macromolecule, or the like. The water-soluble macromolecule may be a different type of compound from the surfactant compound described above.

The water-soluble macromolecule may be a compound with a weight-average molecular weight (polystyrene conversion value) equal to or more than 10000. The weight-average molecular weight described above is measured by, for example, a gel permeation chromatography (GPC) using tetrahydrofuran (THF). The compound that has a weight-average molecular weight described above less than 10000 may be determined not to correspond to the water-soluble macromolecule described above.

The K-value of the water-soluble macromolecule may be adjusted such that the hydrophilicity of the coating film of the composition can sufficiently improve and the solubility in the solvent included in the composition sufficiently increases. The K-value described above is the K-value based on Fikentscher's formula at 25° C., for example. Specifically, the K-value of the water-soluble macromolecule is preferably 10 or more and 200 or less and more preferably 80 or more and 150 or less.

The content of the water-soluble macromolecule in the composition is adjusted in consideration of the viscosity of the composition, for example. The content of the water-soluble macromolecule in the composition is adjusted such that there is no problem in treating the composition, for example. Specifically, the content of the water-soluble macromolecule is preferably 0.001% by mass or more and 50% by mass or less, and more preferably 0.01% by mass or more and 30% by mass or less.

The water-soluble macromolecule is added to the composition to improve the hydrophilicity of the coating film of the composition. In this way, the scale adhesion prevention performance of the coating film improves.

### (pH Adjusting Agent)

When the pH adjustment of the composition is required, various acids and/or alkali compounds are used as a pH adjusting agent. The pH of the composition is adjusted as appropriate depending on the type of the compound constituting the composition and/or the type of the raw material of the composition. When the pH of the composition is adjusted, the pH of the composition is preferably adjusted to 6 to 14, is more preferably adjusted to 8 to 13, and is even more preferably adjusted to 9 to 12.

Examples of the acids include hydrochloric acid, sulfuric acid, nitric acid, phosphoric acid, diphosphoric acid, myo-inositol-1,2,3,4,5,6-hexaphosphate, or the like. Examples of alkali compounds include an alkali metal compound, an amine compound, or the like. Examples of alkali metal compounds include LiOH, NaOH, KOH, Na₂CO₃, Na₂HPO₄, or the like. Examples of amine compounds include NH₃, methylamine, ethylamine, ethylenediamine, or the like.

The compound used as the catalyst described above may also be used as a pH adjusting agent. For example, the base such as the alkali metal hydroxide described above or the like is used as a pH adjusting agent. Similarly, the thiol compound described above may be used as a pH adjusting agent. The increase in the added amount of the thiol compound may lead to the reduction in the added amount of other pH adjusting agents.

### (III. The Production Method of the Composition)

The composition including an addition condensation product of an aromatic compound and a carbonyl compound, and a thiol compound is produced by the procedure described below, for example. First, a mixture of a solvent, an aromatic compound, a carbonyl compound, and a thiol compound (sometimes referred to as a raw material solution) is prepared. As described above, the raw material solution may include, for example, a surfactant and/or a pH adjusting agent. Then, in the presence of a catalyst and a surfactant, the aromatic compound and the carbonyl compound included in the mixture are reacted. In this way, the addition condensation product of the aromatic compound and the carbonyl compound is generated. As a result, the composition including the addition condensation product of the aromatic compound and the carbonyl compound, and the thiol compound is produced. The production method of the composition described above is described below in detail.

### (IV. Use of the Composition as a Scale Adhesion Prevention Agent)

As described above, the composition according to the present embodiment is used as a scale adhesion prevention agent. Particularly, the composition described above is used as a polymer scale adhesion prevention agent when producing a polymer through polymerization of a monomer mixture mainly containing vinyl chloride or vinyl chloride.

According to one embodiment, the stock solution of the addition condensation product is used as a scale adhesion prevention agent. In this case, the content of the addition condensation product in the stock solution described above may be 0.1% by mass or more and 15% by mass or less. According to another embodiment, the solution (sometimes referred to as an adjusted solution) obtained by adding any solvent (sometimes referred to as an adjustment solvent) to the stock solution of the addition condensation product is used as a scale adhesion prevention agent. The adjusted solution may be produced by adding, to the stock solution of the addition condensation product, at least one of the adjustment solvent, a pH adjusting agent, a reduction agent, and a water-soluble macromolecule. The content of the addition condensation product in the adjusted solution may be 0.1% by mass or more and 15% by mass or less.

The polymerization reactor described above may be coated with the coating liquid including the addition condensation product described above during the production process of an olefin-based polymer, for example. The coating liquid described above is suitably used particularly during the polymerization process of the ethylenically unsaturated group-containing monomers. The coating liquid described above is suitably used during the process to produce the polymer or copolymer of the ethylenically unsaturated group-containing monomer or the copolymer of the monomer mixture described above by subjecting a vinyl halide such as vinyl chloride, a vinylidene halide such as vinylidene chloride, or a monomer mixture mainly including these and also including other monomers to suspension polymerization or emulsion polymerization in aqueous medium.

In suspension polymerization or emulsion polymerization, various additives may be added to the polymerizing system as needed. Examples of additives include a suspension stabilizer, an anionic emulsifier, a nonionic emulsifier, a stabilizer, a chain transfer agent, a pH adjusting agent, or the like. Examples of suspension stabilizers include partially saponified polyvinyl alcohol, methyl cellulose, or the like. Examples of anionic emulsifiers include sodium lauryl sulfate. Examples of nonionic emulsifiers include sorbitan monolaurate, polyoxyethylene alkyl ether, or the like. Examples of stabilizers include tribasic lead sulfate, calcium stearate, dibutyltin dilaurate, dioctyltin mercaptide, or the like. Examples of chain transfer agents include trichloroethylene, mercaptans, or the like. The coating film derived from the coating liquid including the addition condensation product described above may effectively suppress the adhesion of the polymer scale even if these additives exist in the polymerizing system.

The coating film formed of the coating liquid including the addition condensation product described above also exhibits high durability when they are applied to the polymerization of monomers having high solubility to the conventionally well-known coating film having an adhesion prevention performance of the polymer scale, for example, α-methyl styrene, acrylic acid ester, methacrylic acid ester, acrylonitrile, vinyl acetate, or the like. Therefore, the coating liquid including the addition condensation product described above is also suitably used for the production of polymer bead or latex such as polystyrene, polymethyl methacrylate, polyacrylonitrile, or the like, the production of synthetic rubber such as styrene butadiene rubber (SBR), acrylonitrile butadiene rubber (NBR), chloroprene rubber (CR), isoprene rubber (IR), butyl rubber (IIR), or the like (it is noted that these synthetic rubbers are usually produced by emulsion polymerization), and the production of ABS resin.

As described above, the composition according to the present embodiment includes a thiol compound. In addition, the various physical properties of the composition described above are adjusted while it includes a thiol compound. Similarly, the constitution of the coating liquid formed of the composition described above is adjusted while it includes a thiol compound. In this way, when the scale prevention layer 116 is formed on the inner surface 114 of the reaction vessel 110, the degradation of the addition condensation product of the aromatic compound and the carbonyl compound, which is the active ingredient of the scale adhesion prevention agent, is suppressed. As a result, a fine coating film of the addition condensation product is formed as the scale prevention layer 116 derived from the composition described above. In addition, the scale prevention layer 116 with an excellent scale adhesion prevention performance is formed to improve the productivity of the polymer. In addition, the contamination of foreign objects into a product is suppressed.

### (V. The Procedure to Form the Scale Prevention Layer 116)

For example, the inner surface 114 of the reaction vessel 110 is coated with the composition adjusted according to the procedure described above to form the coating film of the addition condensation product described above. In this way, the addition condensation product adheres to the inner surface 114 of the reaction vessel 110.

The method for the coating with the composition described above is not particularly limited. For example, first, the coating liquid including the composition described above is adjusted. As described above, examples of coating liquids include (i) a stock solution obtained through a condensation reaction, (ii) an adjusted solution obtained by adding to the stock solution at least one of a pH adjusting agent, a reduction agent, a water-soluble macromolecule, or water, or the like. Then, the coating liquid described above is sprayed from a nozzle so that the inside of the reaction vessel 110 is coated with the coating liquid. For example, at least part of the inner surface 114 of the reaction vessel 110 is coated with the coating liquid. Examples of the carriers to spray the coating liquid described above from the nozzle include nitrogen, air, water vapor, or the like. The nozzle described above may be arranged at the outlet provided on a relatively upper portion (sometimes referred to as an upper layer) of the reaction vessel 110. The procedure for the coating with the composition is described below in detail.

### (VI. The Constitution and Adhesion Amount of the Addition Condensation Product)

The adhesion amount of the addition condensation product in the composition to the reaction vessel 110 is determined based on, for example, the peak area of the measurement result (sometimes referred to as a chromatogram) obtained through the high performance liquid chromatography (HPLC). in addition, as described above, the composition described above may include a first condensation product and a second condensation product. The content proportion of the first condensation product and/or the second condensation product in the composition and the content ratio of the first condensation product to the second condensation product may be derived by using the chromatogram described above. The detail of the apparatus used for the high performance liquid chromatography (sometimes referred to as a chromatograph) and the measurement condition may be the same as those described above.

### (VII. The Material of Each Unit of the Polymerization Apparatus 100)

The material of each unit of the polymerization apparatus 100 is determined as appropriate in consideration of mechanical strength, corrosion resistance, heat transfer properties or the like. For example, examples of materials used for the stirring shaft 122, the stirring blade 124, the baffle 130, and/or, the cooling tube 140 include stainless steel such as high chromium, high purity ferritic stainless steel, two-phase stainless steel, austenitic stainless steel, or the like. These materials have excellent heat transfer properties and corrosion resistance.

Examples of the materials of the body 112 of the reaction vessel 110 include carbon steel, stainless steel, nickel alloy, titanium alloy, aluminum alloy, or the like. Examples of the materials of the inner surface 114 of the reaction vessel 110 include carbon steel, stainless steel, nickel alloy, titanium alloy, aluminum alloy, or the like. The material of the inner surface 114 of the reaction vessel 110 may be clad steel including stainless steel. The material of the outer layer of the clad steel described above is preferably carbon steel, and the material of the inner layer of said clad steel is preferably stainless steel.

The surface of the body 112 and/or the inner surface 114 of the reaction vessel 110 may undergo a polishing process as needed. Examples of the polishing process include mechanical polishing, electrolytic polishing, or the like. The surface of the body 112 and/or the inner surface 114 of the reaction vessel 110 may undergo a plating process as needed.

### (VIII. The Application of the Polymerization Apparatus 100)

As described above, the polymerization apparatus 100 is used for the production of a polymer. Examples of the polymerization manners include suspension polymerization, emulsion polymerization, bulk polymerization, solution polymerization, or the like. For the production of the polymer, various additives such as an emulsifier, a stabilizer, a lubricant, a plasticizer, a pH adjusting agent, a chain transfer agent, or the like may be used. In this way, the adhesion of the polymer scale may be prevented more effectively, for example.

In suspension polymerization, for example, first, water and a dispersing agent are charged into the reaction vessel 110, and then a polymerization initiator is charged into the reaction vessel 110. The amounts of water, the dispersing agent, and the polymerization initiator are, for example, 20 to 500 parts by mass of water, 0.01 to 30 parts by mass of the dispersing agent, and 0.01 to 5 parts by mass of the polymerization initiator per 100 parts by mass of monomer described below.

Then, the inside of the reaction vessel 110 is exhausted. According to one practical example, the inside of the reaction vessel 110 is depressurized to about 0.001 to 101 kPa·G (about 0.01 to 760 mmHg). According to another practical example, the inside of the reaction vessel 110 is adjusted to the pressure of the atmosphere. Then, some amounts of monomers are charged so that the inner pressure of the reaction vessel 110 becomes, for example, 49 to 2940 kPa·G (0.5 to 30 kgf/cm²·G).

Subsequently, the temperature inside the reaction vessel 110 is adjusted to a predetermined reaction temperature. In this way, a polymerization reaction starts. The reaction temperature described above is for example, 30 to 150° C. The reaction temperature during the polymerization varies depending on the type of the monomer to be polymerized. For example, for the polymerization of vinyl chloride, the reaction temperature is 30 to 80° C. For example, for the polymerization of styrene, the reaction temperature is 50 to 150° C.

While the polymerization reaction is proceeding, water, a dispersing agent, and one type or two or more types of polymerization initiators are added as needed. Subsequently, the polymerization reaction is regarded to be terminated at the moment when the inner pressure of the reaction vessel 110 falls to 0 to 686 kPa·G (0 to 7 kgf/cm²·G) or at the moment when the difference between the inlet temperature and the outlet temperature of cooling water that flows into and flows out of the flow channel 172 of the jacket 170 becomes less than a predetermined value (that is, the moment at which the heat due to the polymerization reaction is no longer generated).

In solution polymerization, an organic solvent, instead of water, is used as the polymerization medium. Examples of organic solvents include toluene, xylene, pyridine, or the like. In the solution polymerization, a dispersing agent is also used as needed. Other conditions and procedures may be similar to those of suspension polymerization.

In bulk polymerization, after the inside of the reaction vessel 110 is exhausted in a similar procedure to that of the suspension polymerization and a monomer and a polymerization initiator are charged into the reaction vessel 110, the temperature inside the reaction vessel 110 is adjusted to a predetermined reaction temperature. The reaction temperature described above is, for example, −10 to 250° C. It is noted that, for example, for the polymerization of vinyl chloride, the reaction temperature is 30 to 80° C. For example, for the polymerization of styrene, the reaction temperature is 50 to 150° C.

More specifically, the polymerization apparatus 100 is used for the application to produce a polymer by polymerizing various vinyl-based monomers, for example, olefins such as ethylene, propylene, or the like, vinyl halides such as vinyl chloride, vinylidene chloride, or the like, vinyl esters such as vinyl acetate or the like, vinyl ethers such as ethyl vinyl ether or the like, (meth) acrylic acid esters such as

methyl methacrylate or the like, metal salts or esters such as maleic acid or fumaric acid, aromatic vinyl such as styrene or the like, diene-based monomers such as butadiene, chloroprene, isoprene, or the like, acrylonitrile, or the like. The polymerization apparatus 100 is particularly suitably used for application of producing a polymer by polymerizing vinyl chloride or a monomer mixture mainly composed of this.

When the polymer is produced by using the polymerization apparatus 100, each raw material is supplied from a supply port (not illustrated) of the polymerization apparatus, and, at the moment when the temperature of the reaction compound charged inside the reaction vessel 110 reaches a predetermined temperature, coolant is circulated through each of the baffle 130, the cooling tube 140, and the jacket 170 to start the heat removal of the reaction compound. On the other hand, a time to start heat removal by the reflux condenser 180 is preferably when a polymerization conversion rate reaches 4% or later, and is more preferably when the polymerization conversion rate is 4 to 20%.

Even when a polymer is produced by using the polymerization apparatus 100, various polymerization conditions may be similar to well-known polymerization conditions. As the polymerization conditions described above, charge proportion of raw material or the like, charging method of raw material or the like, polymerization temperature or the like are exemplified.

For example, when a vinyl chloride-based polymer is produced by suspension polymerization by using the polymerization apparatus 100, charge of an aqueous media, vinyl chloride monomer, in some cases another comonomer, dispersing aid, polymerization initiator or the like is performed similarly to a well-known production method of a vinyl chloride-based polymer. In addition, polymerization conditions may be similar to that of the well-known production method of a vinyl chloride-based polymer.

As a monomer to be polymerized, other than vinyl chloride alone, a monomer mixture mainly composed of vinyl chloride (50% by mass or more of vinyl chloride) can be used. As a comonomer to be copolymerized with vinyl chloride, for example, vinyl esters such as vinyl acetate, vinyl propionate or the like; acrylic acid esters or methacrylic acid esters such as methyl acrylate, ethyl acrylate or the like; olefins such as ethylene, propylene or the like; maleic anhydride; acrylonitrile; styrene; vinylidene chloride; and other monomers that can be copolymerized with vinyl chloride are exemplified.

As the dispersing aid described above, a compound used usually when polymerizing vinyl chloride in aqueous media is used. As the dispersing aid described above, water soluble cellulose ethers such as methyl cellulose, hydroxyethyl cellulose, hydroxypropyl cellulose, hydroxypropyl methylcellulose or the like; partially saponified polyvinyl alcohol, acrylic acid polymers; and water-soluble polymers or the like such as gelatin or the like are exemplified. The dispersing aid described above may be used alone, and may be used in a combination of two types or more. The dispersing aid is, for example, added in an amount of 0.01 to 5 parts by mass per 100 parts by mass of monomer to be charged.

A compound that is usually used in the polymerization of vinyl chloride-based compound is used as the polymerization initiator. As for the polymerization initiator described above, percarbonate compounds such as diisopropyl peroxydicarbonate, di-2-ethylhexyl peroxydicarbonate, diethoxyethyl peroxydicarbonate or the like; perester compounds such as α-cumylperoxyneodecanate, t-butylperoxyneodecanate, t-butylperoxyneoheptanoate, hexylperoxyneodecanate, octylperoxyneodecanate or the like; peroxides such as acetylcyclohexylsulfonyl peroxide, 2,4,4-trimethylpentyl-2-peroxyphenoxyacetate or the like; and azo compounds such as azobis-2,4-dimethylvaleronitrile, azobis(4-methoxy-2,4-dimethylvaleronitrile) or the like are exemplified. Other examples of polymerization initiators include bis(2-ethylhexyl) peroxydicarbonate, 3,5,5-trimethylhexanoyl peroxide, cumene hydroperoxide, cyclohexanone peroxide, t-butyl peroxypivalate, bis(2-ethoxyethyl) peroxydicarbonate, dibenzoyl peroxide, diisopropylbenzene hydroperoxide, lauroyl peroxide, 2,4-dichlorobenzoyl peroxide, α, α′-azobisisobutyronitrile, α, α′-azobis-2,4-dimethylvaleronitrile, di-2-ethylhexyl diperoxyisophthalate, potassium persulfate and ammonium persulfate, or the like.

The polymerization initiator described above may be used alone, or may be used in a combination of two types or more. The polymerization initiator, for example, may be added in an amount of 0.01 to 3 parts by mass per 100 parts by mass of monomer, and is preferably added in an amount of 0.05 to 3 parts by mass per 100 parts by mass of monomer.

A polymerization adjusting agent, a chain transfer agent, a pH adjusting agent, a buffer, a gelling improving agent, an antistatic agent, a scale adhesion prevention agent, or the like which are used for the polymerization of vinyl chloride as appropriate may be further added as needed. Regarding the reduced viscosity (K-value) of the vinyl chloride polymer obtained in the present invention, although a polymer in a desired range can be obtained by using the apparatus of the present invention, preferably, a polymer in a range of 40 to 90 can be obtained.

As for the pH adjusting agent or the buffer, citric acid, trisodium citrate, diammonium citrate, triammonium citrate, potassium hydrogen phthalate, sodium nitrate, sodium carbonate, potassium carbonate, cesium carbonate, sodium hydrogen carbonate, sodium hydroxide, potassium hydroxide, barium hydroxide, disodium phosphate, dipotassium phosphate, tripotassium phosphate or the like are exemplified. The pH adjusting agent or buffer described above may be used alone, and may be used in a combination of two types or more.

The polymerization apparatus 100 may be an example of a reaction apparatus. The reaction vessel 110 may be an example of a reactor. The inner surface 114 of the reaction vessel 110 may be an example of an inner wall surface of the reactor. The scale prevention layer 116 may be an example of the condensation product layer. The reflux condenser 180 may be an example of a condensing unit. The stock solution of the addition condensation product may be an example of the composition. The adjusted solution may be an example of the composition.

The cyclic condensation product of an aromatic compound and a carbonyl compound may be an example of the first component. The linear condensation product of an aromatic compound and a carbonyl compound may be an example of the second component. The first condensation product may be an example of a first type of addition condensation product. The second condensation product may be an example of a second type of addition condensation product.

### (An Example of Another Embodiment)

In the present embodiment, the detail of the polymerization apparatus 100 is described with reference to an example in which the scale prevention layer 116 is formed on the inner surface 114 of the reaction vessel 110. However, the polymerization apparatus 100 is not limited to the present embodiment. In another embodiment, in addition to the inner surface 114 of the reaction vessel 110, the scale prevention layer 116 may be formed on at least one surface of the stirrer 120, the baffle 130, or the cooling tube 140.

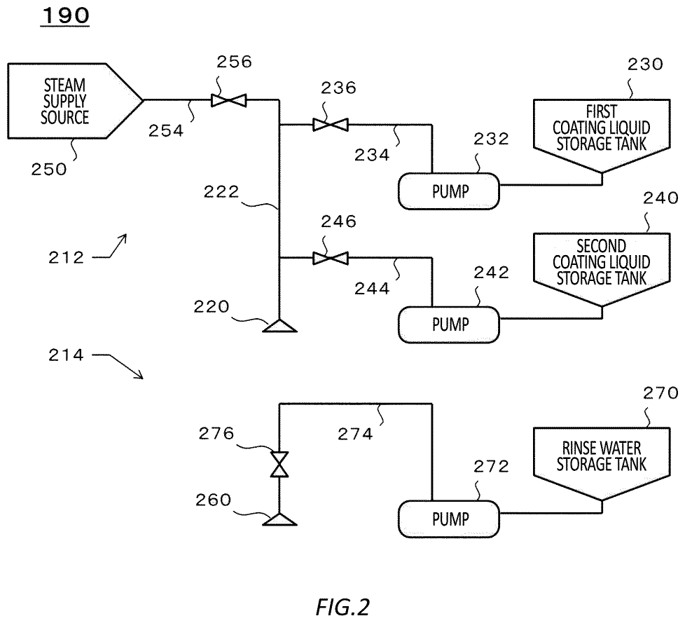

FIG. 2 schematically illustrates an example of the coating apparatus 190. In the present embodiment, the coating apparatus 190 includes, for example, a coating liquid supply unit 212 and a rinse water supply unit 214.

In the present embodiment, the coating liquid supply unit 212 includes, for example, a coating nozzle 220 and a line 222. The coating liquid supply unit 212 includes, for example, a first coating liquid storage tank 230, a pump 232, a line 234, and a valve 236. The coating liquid supply unit 212 includes, for example, a second coating liquid storage tank 240, a pump 242, a line 244, and a valve 246. The coating liquid supply unit 212 includes, for example, a steam supply source 250, a line 254, and a valve 256.

In the present embodiment, the rinse water supply unit 214 includes, for example, a rinse nozzle 260. The rinse water supply unit 214 includes, for example, a rinse water storage tank 270, a pump 272, a line 274, and a valve 276.

### (Overview of Each Unit of the Coating Liquid Supply Unit 212)

In the present embodiment, the coating nozzle 220 ejects, into the reaction vessel 110, the first coating liquid supplied from the first coating liquid storage tank 230, the second coating liquid supplied from the second coating liquid storage tank 240, and steam supplied from the steam supply source 250. The coating nozzle 220 is arranged downward, for example. The coating nozzle 220 is arranged above the region inside the reaction vessel 110 in which the scale prevention layer 116 is formed, for example. The line 222 supplies, to the coating nozzle 220, the first coating liquid supplied from the first coating liquid storage tank 230, the second coating liquid supplied from the second coating liquid storage tank 240, and the steam supplied from the steam supply source 250.

In the present embodiment, the first coating liquid storage tank 230 stores the first coating liquid including the composition described above. The detail of the first coating liquid is described below. The pump 232 transfers the first coating liquid stored in the first coating liquid storage tank 230. The line 234 connects the outlet of the pump 232 to the line 222. The valve 236 is arranged in the middle of the line 234 and adjusts the flow rate of the first coating liquid.

In the present embodiment, the second coating liquid storage tank 240 stores the second coating liquid with a constitution different from the first coating liquid. The second coating liquid is used, for example, to wash away the extra addition condensation product that coats the inner surface of the reaction vessel 110 during the formation process of the scale prevention layer 116. The content of the composition described above in the second coating liquid may be less than the content of the composition described above in the first coating liquid. The second coating liquid may not substantially include the composition described above. The detail of the second coating liquid is described below. The pump 242 transfers the second coating liquid stored in the second coating liquid storage tank 240. The line 244 connects the outlet of the pump 242 to the line 222. The valve 246 is arranged in the middle of the line 244 and adjusts the flow rate of the first coating liquid.

In the present embodiment, the steam supply source 250 supplies steam to the line 254. The steam may be saturated steam or may be superheated steam. The pressure of the steam may be 0.1 to 3.5 MPaG or may be 0.1 MPaG to 2.0 MPaG. The pressure of the steam is preferably 0.28 to 2.0 MPaG and more preferably 0.5 to 1.0 MPaG. The temperature of the steam may be 120 to 270° C. and is preferably 140 to 230° C. The temperature and pressure described above may be the measurement value at the position that is near the valve 256 of the line 254 and is on the side of the steam supply source 250. The line 254 connects the steam supply source 250 to the line 222. The valve 256 is arranged in the middle of the line 254 and adjusts the flow rate of the steam.

When the coating with the composition described above is performed by using steam as a carrier, the coating time may be 10 seconds to 1000 seconds and is preferably 30 seconds to 300 seconds. The value obtained by dividing the mass flow of the composition described above by the mass flow of the steam (sometimes referred to as a mass flow ratio) may be 0.01 to 1.00 and is preferably 0.02 to 0.2.

In the present embodiment, the rinse nozzle 260 ejects, into the reaction vessel 110, the water supplied from the rinse water storage tank 270. The rinse nozzle 260 is arranged downward, for example. The rinse nozzle 260 is arranged above the region inside the reaction vessel 110 in which the scale prevention layer 116 is formed, for example.

In the present embodiment, the rinse water storage tank 270 stores water to be used for rinse (sometimes referred to as rinse water). The pump 272 transfers the rinse water stored in the rinse water storage tank 270. The line 274 connects the outlet of the pump 272 to the rinse nozzle 260. The valve 276 is arranged in the middle of the line 274 and adjusts the flow rate of the rinse water.

### (An Example of Another Embodiment)

In the present embodiment, the detail of the coating apparatus 190 is described with reference to an example in which the constitution of the first coating liquid is different from the constitution of the second coating liquid. However, the coating apparatus 190 is not limited to the present embodiment. In another embodiment, the constitution of the first coating liquid may be the same as the constitution of the second coating liquid. In this case, the coating apparatus 190 may not include the second coating liquid storage tank 240, the pump 242, the line 244, and the valve 246. In yet another embodiment, both the first coating liquid and the second coating liquid may include the composition described above. In yet another embodiment, the first coating liquid may not substantially include the composition described above and the second coating liquid may include the composition described above.

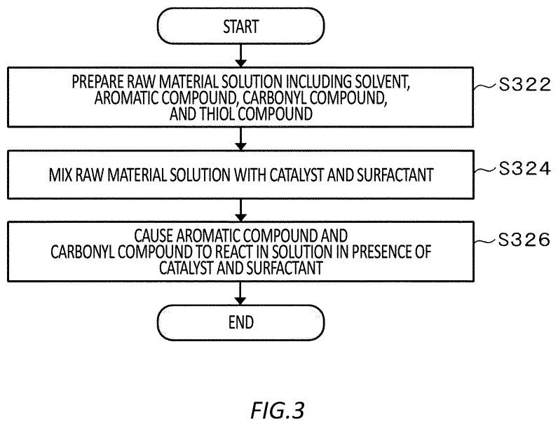

FIG. 3 schematically illustrates an example of the production method for the composition. According to the present embodiment, first, the raw material solution is prepared in step 322 (the steps are sometimes simply referred to as S). As described above, the raw material solution includes a solvent, an aromatic compound, a carbonyl compound, and a thiol compound.

As described above, the raw material solution may include a single type of aromatic compound or may include two or more types of aromatic compounds. Similarly, the raw material solution may include a single type of carbonyl compound or may include two or more types of carbonyl compound.

The ratio of the aromatic compound and the carbonyl compound is selected as appropriate according to the types of the aromatic compound, the carbonyl compound, the reaction solvent, and the catalyst to be used, the reaction time, the reaction temperature, or the like. The raw material solution includes, for example, 0.1 to 10 mole of carbonyl compound per 1 mole of aromatic compound. The raw material solution may include 0.5 to 3.0 mole of carbonyl compound per 1 mole of aromatic compound. The raw material solution may include 0.1 mole or more and less than 1 mole (for example, 0.999 mole) of carbonyl compound per 1 mole of aromatic compound and may include 0.5 mole or more and less than 1 mole (for example, 0.99 mole) of carbonyl compound per 1 mole of aromatic compound. In this way, the molar ratio of the aromatic compound dimer and the aromatic compound polymer described above may be adjusted within the numeric range described above.

The raw material solution is then mixed with the catalyst and the surfactant in S324. As described above, the catalyst may be an alkali metal hydroxide. Similarly, the surfactant may be a well-known anionic surfactant. In addition, the aromatic compound and the carbonyl compound (sometimes referred to as reaction components) are reacted in the reaction solvent in the presence of the catalyst and the surfactant in S326. In this way, the condensation reaction of the aromatic compound and the carbonyl compound occurs and the addition condensation product of the aromatic compound and the carbonyl compound is generated.

The reaction described above is performed such that a predetermined condition related to temperature and/or time is met. To start, proceed, or stop the reaction described above, a plurality of processes with different conditions related to temperature and/or time may be performed. After the reaction described above is started, a plurality of processes with different conditions related to temperature and time may be performed.

The conditions related to temperature are not particularly limited, but examples of the conditions related to temperature include the condition that the temperature is room temperature to 200° C., the condition that the temperature is 30 to 150° C., or the like. The condition related to time is not particularly limited, but examples of the condition related to time include the condition that the time is 1 to 100 hours, the condition that the time is 1 to 30 hours or the like. The condition related to temperature and time may be the combination of any condition related to temperature and any condition related to time. Examples of the condition related to temperature and time include the condition that the temperature is room temperature to 200° C. and the time is 1 to 100 hours.

The reaction temperature and the reaction time of the condensation reaction may be the room temperature to 200° C. and 1 to 100 hours, respectively, and is preferably 30 to 150° C. and 2 to 30 hours, respectively. The reaction temperature and the reaction time of the condensation reaction may be the room temperature to 97° C. and 1 to 100 hours, respectively, and is preferably 30 to 95° C. and 2 to 30 hours, respectively. In this way, the molar ratio of the aromatic compound dimer and the aromatic compound polymer described above may be adjusted within the numeric range described above.

The maximum reachable temperature in the condensation reaction may be 60 to 97° C. The condensation reaction may be controlled so that the reaction temperature and the reaction time are the maximum reachable temperature and 1 to 100 hours, respectively. The condensation reaction is preferably controlled so that the reaction temperature and the reaction time are the maximum reachable temperature and 2 to 30 hours, respectively.

The pH of the medium used for the condensation reaction described above may be in the range of 1 to 14. The pH described above may be 1 to 12. The pH described above may be 6 to 14, may be 8 to 13, or may be 9 to 12. The pH of the medium described above may be adjusted with any pH adjusting agent. As the pH adjusting agent, an alkali metal hydroxide, for example, lithium hydroxide, sodium hydroxide, potassium hydroxide, or the like is used. In this way, the high solubility of the condensation product may be maintained.

In this way, the composition including an addition condensation product (for example, the particular addition condensation product described above) is obtained. The addition condensation product in the composition is the aromatic compound polymer in which each of the two or more (preferably 2 to 50) building blocks derived from an aromatic compound connects to each other via one building block derived from a carbonyl compound. The addition condensation product includes, for example, an aromatic compound dimer, as well as an aromatic compound trimer (for example the compound represented as A-B-A-B-A) up to an aromatic compound 50 mer (for example, the compound represented as A-B-A . . . B-A and including 50 As).

According to the present embodiment, the composition including an addition condensation product of an aromatic compound and a carbonyl compound, and a thiol compound is obtained. In addition, at least part of the inner surface 114 of the body 112 is coated with the coating liquid prepared by using the composition described above to form the fine scale prevention layer 116. Therefore, the adhesion of the scale involved in the polymerization is suppressed. In addition, the scale prevention layer 116 is prevented from being fallen off from the inner surface 114 of the reaction vessel 110 together with the scale adhering to the scale prevention layer 116.

In contrast, for example, Patent Document 2 discloses a polymer scale adhesion prevention agent comprised of a first coating liquid containing quinone-based compound condensation product and a second coating liquid including polyphosphoric acid. When the polymer is synthesized by using a reaction vessel having a scale prevention layer formed of the polymer scale adhesion prevention agent according to Patent Document 2, the adhesion of scale during the polymerization is suppressed. However, the scale prevention layer formed of the polymer scale adhesion prevention agent described in Patent Document 2 easily falls off from the inner surface of the reaction vessel together with the scale adhering to the scale prevention layer. The mixture of the scale prevention layer and the scale falling from the inner surface of the reaction vessel may contaminate the product as a foreign object, causing fish eye, for example.

### (An Example of Another Embodiment)

In the present embodiment, an example of the production method of the composition described above is described with reference to the example in which the thiol compound is added to the raw material solution before the raw material solution is mixed with the catalyst and the surfactant. However, the production method of the composition described above is not limited to the present embodiment. The timing at which the thiol compound is added to the raw material solution is not particularly limited as long as it is before the termination of the condensation reaction.

it is noted that, when the condensation reaction of the aromatic compound and the carbonyl compound is started without the thiol compound being added, the addition condensation product of the aromatic compound and the carbonyl compound may condense depending on the adjustment of the raw material solution. Therefore, for the purpose of improving the flexibility of the adjustment of the raw material solution, the thiol compound is preferably added to the raw material solution before the condensation reaction of the aromatic compound and the carbonyl compound is started.

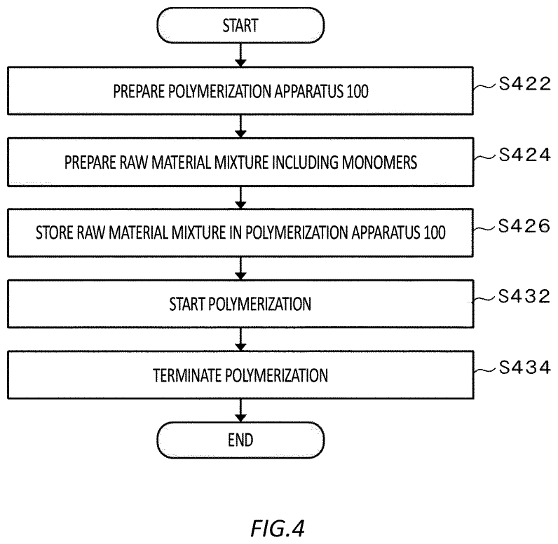

FIG. 4 schematically illustrates an example of a production method for a polymer. According to the present embodiment, first, the polymerization apparatus 100 is prepared in S422. For example, the scale prevention layer 116 is formed on the inner surface 114 of the reaction vessel 110. The scale prevention layer 116 is formed according to the procedure described below, for example.

First, the inner surface 114 of the reaction vessel 110 is preheated by causing heat medium such as hot water, water vapor, or the like to flow into the flow channel 172 of the jacket 170. For example, the preheating process of the inner surface 114 is performed such that the temperature of the inner surface 114 is 20° C. or more, preferably 30 to 95° C.

In addition, a first coating liquid including the composition described above is prepared. In one embodiment, the composition described above including an addition condensation product of an aromatic compound and a carbonyl compound, and a thiol compound is used as the first coating liquid without being diluted by solvent. In another embodiment, the composition described above is diluted by any solvent so that the first coating liquid is adjusted. The solvent described above may be deionized water.

The first coating liquid is adjusted such that the mass proportion of the aromatic compound used to produce the addition condensation product described above relative to the mass of the first coating liquid is 0.2% by mass to 20% by mass, for example. The proportion described above is preferably 1% by mass to 15% by mass and is more preferably 3 to 10% by mass. The proportion described above may be about 5% by mass (for example, 4 to 6% by mass). The first coating liquid adjusted according to the procedure described above is stored in the first coating liquid storage tank 230.

Similarly, the second coating liquid described above is prepared. The second coating liquid is stored in the second coating liquid storage tank 240. In the present embodiment, the second coating liquid includes at least one type of auxiliary agent. As described above, the second coating liquid may not substantially include the composition described above.

The second coating liquid includes, for example, a water-soluble macromolecule. The water-soluble macromolecule may be poly(N-vinylpyrrolidone). This may remove the extra addition condensation product that coats the inner surface of the reaction vessel 110 during the formation process of the scale prevention layer 116.

In addition, the second coating liquid includes the water-soluble macromolecule so that the coating film formed on the inner surface of the reaction vessel 110 becomes soft and thus a part of the coating film falls off during the batch polymerization process. As a result, after the polymerization, the amount of coating film remaining on the inner surface of the reaction vessel 110 may decrease. Since the thickness of the coating film described above is approximately 10 nm, even if the coating film falls off during the batch polymerization process, the coating film falling off has a relatively small effect on the quality of the polymer.

In contrast, the repeat of starting the next batch polymerization process with a relatively large amount of coating film remaining on the inner surface of the reaction vessel 110 results in the formation of an accumulation layer, in which a coating film, an unreacted monomer, a polymerization aid, and the like accumulate in combination, on the inner surface of the reaction vessel 110. Since the thickness of the accumulation layer is relatively large, it is contemplated that the accumulation layer falling off during the batch polymerization process causes a foreign object having a size in a micron order or more to contaminate the polymer. According to the present embodiment, since the contamination of such a large foreign object into the polymer is suppressed, the polymer having a good quality is obtained.

The second coating liquid includes, for example, a pH adjusting agent. The pH adjusting agent may include a phosphate-based compound. The phosphate-based compound may be myo-inositol-1,2,3,4,5,6-hexaphosphate. The phosphate-based compound acts on the material of the inner surface of the reaction vessel 110 (for example, stainless steel) so that the extra iron on the inner surface of the reaction vessel 110 dissolves. In this way, the corrosion resistance of the inner surface of the reaction vessel 110 improves. As a result, the adhesion of the scale to the inner surface of the reaction vessel 110 is suppressed.

The second coating liquid includes, for example, a base. The base may be ethylenediamine. The pH of the second coating liquid may be alkaline. In this way, the precipitation of solid or gel when mixing the first coating liquid and the second coating liquid is suppressed. As a result, the blocking of the line 222 is suppressed.

### (Coating of the First Layer)

Then, the first coating liquid is supplied into the reaction vessel 110. Specifically, first, the opening degree of the valve 256 is adjusted and steam is supplied to the coating nozzle 220. Then, the first coating liquid is supplied to the line 222 through the activation of the pump 232 and the adjustment of the opening degree of the valve 236. In this way, the first coating liquid is carried by the steam into the reaction vessel 110. The mixing ratio (L/G) of the steam (G) and the coating liquid (L) may be 0.01 to 1.0 and is preferably 0.02 to 0.3 in the flow rate ratio based on mass.

The coating time of the first coating liquid is adjusted so that the coating film with an amount effective for preventing the adhesion of scale is formed. The coating time of the first coating liquid may be 1 second or more and 600 seconds or less and is preferably 10 seconds or more and 300 seconds or less. In this way, the coating film with an amount effective for preventing the adhesion of scale may be produced at an economically reasonable cost.

In this way, the layer derived from the first coating liquid (sometimes referred to as a first coating layer) is formed on the inner surface 114 of the reaction vessel 110. As described above, the first coating layer may also be formed on the surface of the stirring shaft 122, the stirring blade 124, the baffle 130, and/or the cooling tube 140. Subsequently, the valve 236 closes and the pump 232 stops.

### (Coating of the Second Layer)

Then, the second coating liquid is supplied into the reaction vessel 110. Specifically, the second coating liquid is supplied to the line 222 through the activation of the pump 242 and the adjustment of the opening degree of the valve 246 while the steam is supplied to the coating nozzle 220. In this way, the second coating liquid is carried by the steam into the reaction vessel 110. The mixing ratio (L/G) of the steam (G) and the coating liquid (L) may be 0.01 to 1.0 and is preferably 0.02 to 0.3 in the flow rate ratio based on mass.

The coating time of the second coating liquid is adjusted as appropriate in an economically reasonable range. The coating time of the second coating liquid may be 1 second or more and 600 seconds or less and is preferably 10 seconds or more and 300 seconds or less.

In this way, the layer derived from the second coating liquid (sometimes referred to as the second coating layer) is formed on the first coating layer. Subsequently, the valve 246 closes and the pump 242 stops. In addition, the valve 256 closes and the supply of the steam stops.

(Rinse with Water)

Then, the inside of the reaction vessel 110 is rinsed with rinse water. Specifically, first, the rinse water is supplied to the rinse nozzle 260 through the activation of the pump 272 and the adjustment of the opening degree of the valve 276. In this way, the rinse water is carried to the inside of the reaction vessel 110 and the scale prevention layer 116 is rinsed.

Then, the mixture including a monomer (sometimes referred to as a raw material mixture) is prepared in S424. In addition, the raw material mixture is stored inside the reaction vessel 110 in S426. In this way, the charge process of the polymerization reaction is completed.

Then, the polymerization reaction of the monomer is started in S432. In addition, the polymerization reaction of the monomer is terminated in S434. In this way, the polymer is obtained.

As described above, according to the present embodiment, the scale prevention layer 116 derived from the composition described above is formed on the inner surface 114 of the reaction vessel 110. The scale prevention layer 116 includes a fine coating film of the condensation product of an aromatic compound and a carbonyl compound. In this way, the formation and accumulation of the polymer scale is suppressed. As a result, the productivity of the polymer improves. In addition, the contamination of a foreign object including the addition condensation product of the aromatic compound and the carbonyl compound is suppressed.

Specifically, the contamination of the foreign object in which the content of the addition condensation product described above is 1% by mass or more and which has a major axis of 250 μm or more is suppressed. The number of the foreign objects described above included per 200 cm³ of a product polymer is, for example, four or less. The number of the foreign objects described above may be one or more and four or less, may be one or more and three or less, may be two or more and four or less, or may be two or more and three or less. The number of foreign objects described above is measured according to JIS K6737 or in accordance with JIS K 6737.

### EXAMPLES

Hereinafter, examples are shown, and the present invention is specifically described. The present invention is not restricted by the following example.

### Synthesis Example 1

The coating liquid including the addition condensation product and the thiol compound is produced according to the procedure described below. First, preliminary warming is performed by charging 1384 mL of deionized water into the reactor sufficiently replaced by nitrogen that is flowed in, and warming the inside of the reactor to 35° C. while deionized water is stirred. After 5.0 g of 3-mercapto-1,2-propanediol, 12.2 g of sodium hydroxide, and 150.0 g of α-naphthol are added to the deionized water in the reactor, the mixture is stirred for 30 minutes. Subsequently, 71.8 g of 37% by mass formaldehyde aqueous solution is added to the mixture in the reactor.

Then, the temperature in the reactor is warmed to 60° C. and the mixture in the reactor is reacted for three hours. Subsequently, the temperature in the reactor is warmed to 80° C. and the mixture in the reactor is reacted for one hour. Subsequently, the cooling of the reactor is started so that the temperature in the reactor drops to 40° C. In addition, at the moment when the temperature in the reactor drops to 40° C., 219 mL of deionized water is added to the mixture in the reactor. In this way, coating liquid (sometimes referred to as coating liquid No. 1-1) is obtained.

### Synthesis Example 2

Coating liquid (sometimes referred to as coating liquid No. 1-2) is produced according to a similar procedure to the synthesis example 1 except that the charge amount of the deionized water before preliminary warming is 1339 mL and the added amount of 3-mercapto-1,2-propanediol is 10.0 g.

### Synthesis Example 3

Coating liquid (sometimes referred to as coating liquid No. 1-3) is produced according to a similar procedure to the synthesis example 1 except that 5.0 g of 2-mercaptoethanol is added instead of 3-mercapto-1,2-propanediol.

### Synthesis Example 4

Coating liquid (sometimes referred to as coating liquid No. 1-4) is produced according to a similar procedure to the synthesis example 3 except that the charge amount of deionized water before preliminary warming is 1339 mL and the added amount of 2-mercaptoethanol is 10.0 g/

### Synthesis Example 5

Coating liquid (sometimes referred to as coating liquid No. 1-5) is produced according to a similar procedure to the synthesis example 1 except that 5.0 g of sodium dithionite is added instead of 3-mercapto-1,2-propanediol.

### Synthesis Example 6

Coating liquid (sometimes referred to as coating liquid No. 1-6) is produced according to a similar procedure to the synthesis example 1 except that 5.0 g of L-ascorbic acid is added instead of 3-mercapto-1,2-propanediol.

### Synthesis Example 7

Coating liquid (sometimes referred to as coating liquid No. 1-7) is produced according to a similar procedure to the synthesis example 1 except that 5.0 g of N,N-diethylhydroxylamine is added instead of 3-mercapto-1,2-propanediol.

### Synthesis Example 8

Coating liquid that does not substantially include an addition condensation product is produced according to the procedure described below. First, calcium dihydrogen diphosphate aqueous solution is produced by adding 500 mg of calcium dihydrogen diphosphate to 20 ml of deionized water. Then, 930 ml of deionized water and 50 ml of ethanol are charged into the reactor.

Then, 10 g of poly N-vinyl-2-pyrrolidone with a weight-average molecular weight of 2.8 million is added to the deionized water in the reactor while the deionized water in the reactor is stirred. After the confirmation through visual observation that poly N-vinyl-2-pyrrolidone has been dissolved, calcium dihydrogen diphosphate aqueous solution prepared in advance is added to the mixture in the reactor and the mixture is stirred for five hours. In this way, coating liquid (sometimes referred to as coating liquid No. 2-1) is obtained.

### Practical Example 1

### (Formation of Scale Adhesion Prevention Layer)

First, a polymerization vessel made of stainless steel having a similar configuration to the polymerization apparatus 100 described above is prepared. The internal volume of the polymerization vessel is 2 m³. Then, the scale adhesion prevention layer is formed on the inner wall surface and the internal structure surface on the polymerization vessel according to the procedure described below.

First, the inner wall surface of the polymerization vessel is heated to 45° C. by passing hot water through the jacket of the polymerization vessel. Then, the steam of 0.717 MPaG (171.4° C.) is supplied into the polymerization vessel. The supply flow rate of the steam is 240 kg/h and the supply time of the steam is 60 seconds. In this way, the preheating of the polymerization vessel is completed.

Then, the coating liquid No. 1-1 is supplied into the polymerization vessel by using the steam described above as the carrier. The supply flow rate of the coating liquid is 120 g/min and the supply time of the coating liquid is 120 seconds.

Subsequently, the supply of the steam and the coating liquid is stopped. In addition, the passage of hot water through the jacket is stopped. In this way, the scale adhesion prevention layer is formed on the inner wall surface and the internal structure surface of the reactor such as a polymerization vessel or the like.

(Production of polymer)

A vinyl chloride polymer is produced according to the procedure described below by using the polymerization vessel in which the scale adhesion prevention layer is formed according to the procedure described above. First, into the polymerization vessel described above, 200 parts by weight of deionized water, 0.020 parts by weight of partially saponified polyvinyl alcohol, and 0.026 parts by weight of 2-hydroxypropyl methylcellulose (product name: metolose, from Shin-Etsu Chemical Co., Ltd.) are input. In addition, after degassing the inside of the polymerization vessel to 50 mmHg, 100 parts by weight of vinyl chloride monomer (VCM) is charged into the polymerization vessel.

It is noted that metolose from Shin-Etsu Chemical Co., Ltd. has a degree of methoxyl group substitution of 1.9 and a degree of 2-hydroxypropoxyl group substitution of 0.25. The degree of methoxyl group substitution indicates the average number of the hydroxyl groups in a glucose ring unit of cellulose replaced by methoxyl groups. The degree of 2-hydroxypropoxyl group substitution indicates the number of moles of the hydroxyalkoxyl groups added per a glucose ring unit of cellulose.

Then, 0.03 parts by weight of t-butylperoxyneodecanate is transferred by a pump while the reaction mixture stored inside the polymerization vessel is stirred. Subsequently, the hot water is passed through the jacket to heat the raw material while the raw material stored inside the polymerization vessel is stirred. At the moment when the temperature inside the polymerization vessel reaches 52° C., cooling water is passed through the jacket to maintain the temperature inside the polymerization vessel to be 52° C. to proceed the polymerization reaction. At the moment when the pressure inside the polymerization vessel reaches 5 kgf/cm²·G (0.49 MPa·G), the polymerization reaction is terminated. After the unreacted monomer is collected, the slurry, which is the reaction mixture, is removed from the polymerization vessel. Through dehydration and drying of the reaction mixture, vinyl chloride polymer is obtained.

### Practical Example 2

### (Formation of Scale Adhesion Prevention Layer)

First, a polymerization vessel made of stainless steel having a similar configuration to the polymerization apparatus 100 described above is prepared. The internal volume of the polymerization vessel is 2 m³. Then, the scale adhesion prevention layer is formed on the inner wall surface and the internal structure surface on the polymerization vessel according to the procedure described below.

First, the inner wall surface of the polymerization vessel is heated to 45° C. by passing hot water through the jacket of the polymerization vessel. Then, the steam of 0.717 MPaG (171.4° C.) is supplied into the polymerization vessel. The supply flow rate of the steam is 240 kg/h and the supply time of the steam is 60 seconds. In this way, the preheating of the polymerization vessel is completed.

Then, the coating liquid No. 1-1 is supplied into the polymerization vessel by using the steam described above as the carrier. The supply flow rate of the coating liquid is 120 g/min and the supply time of the coating liquid is 120 seconds. Subsequently, the supply of the coating liquid No. 1-1 is stopped. In this way, the first coating layer described above is formed.

Then, the coating liquid No. 2-1 is supplied into the polymerization vessel by using the steam described above as the carrier. The supply flow rate of the coating liquid is 285 g/min and the supply time of the coating liquid is 40 seconds. In this way, the second coating layer described above is formed.

Subsequently, the supply of the steam and the coating liquid No. 2-1 is stopped. In addition, the passage of hot water through the jacket is stopped. In this way, the scale adhesion prevention layer is formed on the inner wall surface and the internal structure surface of the polymerization vessel.

### (Production of Polymer)

A vinyl chloride polymer is produced by using a polymerization vessel in which the scale adhesion prevention layer is formed according to the procedure described above. The procedure to produce the vinyl chloride polymer is similar to that of practical example 1.

### Practical Example 3

The scale adhesion prevention layer is formed on the inner wall surface and internal structure surface of the polymerization vessel according to a similar procedure to practical example 1 except that the coating liquid No. 1-2 is used instead of the coating liquid No. 1-1. In addition, a vinyl chloride polymer is produced according to a similar procedure to that of practical example 1 by using the polymerization vessel described above.

### Practical Example 4

The scale adhesion prevention layer is formed on the inner wall surface and internal structure surface of the polymerization vessel according to a similar procedure to that of practical example 2 except that the coating liquid No. 1-2 is used instead of the coating liquid No. 1-1. In addition, vinyl chloride polymer is produced according to a similar procedure to that of practical example 2 by using the polymerization vessel described above.

### Practical Example 5

The scale adhesion prevention layer is formed on the inner wall surface and internal structure surface of the polymerization vessel according to a similar procedure to that of practical example 1 except that the coating liquid No. 1-3 is used instead of the coating liquid No. 1-1. In addition, a vinyl chloride polymer is produced according to a similar procedure to that of practical example 1 by using the polymerization vessel described above.

### Practical Example 6

The scale adhesion prevention layer is formed on the inner wall surface and internal structure surface of the polymerization vessel according to a similar procedure to that of practical example 2 except that the coating liquid No. 1-3 is used instead of the coating liquid No. 1-1. In addition, vinyl chloride polymer is produced according to a similar procedure to that of practical example 2 by using the polymerization vessel described above.

### Practical Example 7

The scale adhesion prevention layer is formed on the inner wall surface and internal structure surface of the polymerization vessel according to a similar procedure to that of practical example 1 except that the coating liquid No. 1-4 is used instead of the coating liquid No. 1-1. In addition, a vinyl chloride polymer is produced according to a similar procedure to that of practical example 1 by using the polymerization vessel described above.

### Practical Example 8

The scale adhesion prevention layer is formed on the inner wall surface and internal structure surface of the polymerization vessel according to a similar procedure to that of practical example 2 except that the coating liquid No. 1-4 is used instead of the coating liquid No. 1-1. In addition, a vinyl chloride polymer is produced according to a similar procedure to that of practical example 2 by using the polymerization vessel described above.

### Comparative Example 1

The scale adhesion prevention layer is formed on the inner wall surface and internal structure surface of the polymerization vessel according to a similar procedure to that of practical example 1 except that the coating liquid No. 1-5 is used instead of the coating liquid No. 1-1. In addition, a vinyl chloride polymer is produced according to a similar procedure to that of practical example 1 by using the polymerization vessel described above.

### Comparative Example 2

The scale adhesion prevention layer is formed on the inner wall surface and internal structure surface of the polymerization vessel according to a similar procedure to that of practical example 2 except that the coating liquid No. 1-5 is used instead of the coating liquid No. 1-1. In addition, a vinyl chloride polymer is produced according to a similar procedure to that of practical example 2 by using the polymerization vessel described above.

### Comparative Example 3

The scale adhesion prevention layer is formed on the inner wall surface and internal structure surface of the polymerization vessel according to a similar procedure to that of practical example 1 except that the coating liquid No. 1-6 is used instead of the coating liquid No. 1-1. In addition, a vinyl chloride polymer is produced according to a similar procedure to that of practical example 1 by using the polymerization vessel described above.

### Comparative Example 4

The scale adhesion prevention layer is formed on the inner wall surface and internal structure surface of the polymerization vessel according to a similar procedure to that of practical example 2 except that the coating liquid No. 1-6 is used instead of the coating liquid No. 1-1. In addition, a vinyl chloride polymer is produced according to a similar procedure to that of practical example 2 by using the polymerization vessel described above.

### Comparative Example 5

The scale adhesion prevention layer is formed on the inner wall surface and internal structure surface of the polymerization vessel according to a similar procedure to that of practical example 1 except that the coating liquid No. 1-7 is used instead of the coating liquid No. 1-1. In addition, a vinyl chloride polymer is produced according to a similar procedure to that of practical example 1 by using the polymerization vessel described above.

### Comparative Example 6

The scale adhesion prevention layer is formed on the inner wall surface and internal structure surface of the polymerization vessel according to a similar procedure to that of practical example 2 except that the coating liquid No. 1-7 is used instead of the coating liquid No. 1-1. In addition, a vinyl chloride polymer is produced according to a similar procedure to that of practical example 2 by using the polymerization vessel described above.

### (Evaluations of Practical Examples 1 to 8 and Comparative Examples 1 to 6)

### (Scale Adhesion Prevention Effect)

For each of practical examples 1 to 8 and comparative examples 1 to 6, after the termination of the polymerization reaction, the amount of scale adhered to the liquid phase portion of the inner wall surface of the polymerization vessel is observed through visual observation. The result observed is indicated In Table 1.

In the column of “scale adhesion prevention effect” of Table 1, the circle symbols indicate that scale adhesion is not observed. The triangle symbols indicate that scale adhesion to the degree that does not prevent continuous operation is observed. More specifically, the triangle symbols indicate that the number of batches of possible continuous operations is 10 or more batches and less than 100 batches. The cross symbols indicate that scale adhesion to the degree that frequent cleaning is needed is observed. More specifically, the cross symbols indicate that the number of batches of possible continuous operations is less than 10 batches.

### (Foreign Object Contamination Prevention Effect)

For each of practical example 2 and comparative example 2, the number of foreign objects that are included per 200 cm³ of the polymer product and has a major axis of 250 μm or more is measured according to JIS K 6737. The contents of an addition condensation product of an aromatic compound and a carbonyl compound in foreign objects are all 1% by mass or more. The measurement result related to each of practical example 2 and comparative example 2 is indicated in Table 1. In the column of “the number of foreign object” of Table 1, dash symbols indicate that measurement is not performed.

### (The Constitution of the Addition Condensation Product Included in Coating Liquid)

For each of practical examples 2, 4, 6, and 8 and comparative example 2, the constitution of the addition condensation product included in the coating liquid used to produce the scale adhesion prevention layer is determined by a high performance liquid chromatography analysis method. Specifically, the content ratio of the first condensation product to the second condensation product described above

(sometimes referred to as a content ratio in coating liquid) is derived. Table 1 indicates the derivation result related to each of practical examples 2, 4, 6, and 8, and comparative example 2. In the column of “content ratio in coating liquid” in Table 1, dash symbols indicate that the content ratio is not derived. The detail of the apparatus and measurement condition used for the high performance liquid chromatography is described below.

### (The Detail of the Chromatogram and Measurement Condition)

As the chromatograph, Nexera/Prominence, which is a general purpose HPLC, from SHIMADZU CORPORATION is used. As the system controller of the chromatograph described above, SCL-40 (from SHIMADZU CORPORATION) is used. As the liquid feeding unit of the chromatograph described above, two units of LC-40D (from SHIMADZU CORPORATION) are used. The injection amount of the sample is set to 20 μL.

As the online deaerator of the chromatograph described above, DGU-403 (from SHIMADZU CORPORATION) is used. As the autosampler of the chromatograph described above, SIL-20ACHT (from SHIMADZU CORPORATION) is used. As the column oven of the chromatograph described above, CTO-20A (from SHIMADZU CORPORATION) is used. The temperature of the column oven is set to 40° C. As the UV-VIS detector of the chromatograph described above, SPD-20A (from SHIMADZU CORPORATION) is used. The detected wavelength is set to 288 nm.

As the guard column, Puresil (registered trademark) C18 guard column (100 Å, 5 μm, 3.9 mm×20 mm×1) from Waters is used. As the analysis column, μ-Bondasphere/DeltaPak (registered trademark) C18 column (100 Å, 5 μm, 3.9 mm×150 mm×1) from Waters is used.

As the eluent, two types of solutions (referred to as the eluent A and the eluent B) are used. As the eluent A, the solution in which 2 mL of acetic acid is added per 1 L of distilled water is prepared. In addition, as the eluent B, the solution in which 1 ml of acetic acid is added per 1 L of acetonitrile is prepared.

### (An Example of the Detail of the Measurement Procedure)

### (Measurement of Holdup Time t_{O})

First, according to the procedure described with reference to the analytic procedure by the LC method, the holdup time t_{O} is measured. In the measurement of the holdup time t_{O}, the injection amount of the uracil aqueous solution is set to 20 μL. The total value of the flow rate of the eluent A and the eluent B is set to 1.0 ml/min. In addition, as the gradient condition of the eluent, first, the proportion of the eluent B relative to the total amount of eluent is set to 40% by volume. Then, the proportion of the eluent B relative to the total amount of eluent is linearly changed from 40% by volume to 100% by volume in 30 minutes. Then, the proportion of the eluent B relative to the total amount of eluent is kept to be 100% by volume for 10 minutes.

### (Measurement of the Retention Time t_{R} of Each Component Included in Coating Liquid)

First, filtrate is obtained by filtering coating liquid according to each practical example and each comparative example using a polytetrafluoroethylene filter with a pore diameter of 0.45 μm. Then, the filtrate described above is set to the chromatograph described above and the measurement of the retention time t_{R} is started. The measurement condition of the retention time t_{R} is the same as the measurement condition of the holdup time t_{O} described above.

### (Content Ratio in Coating Liquid)

First, the retention factor of each of the plurality of peaks appearing on each chromatogram of each practical example and each comparative example is derived based on the holdup time t_{O} and the retention time t_{R} of each component included in the coating liquid used to produce the scale adhesion prevention layer in each practical example and each comparative example. Then, the content ratio in the coating liquid is derived by dividing the total value of the area of each of one or more peaks appearing in the range of the retention factors 16 or more and 25 or less by the total value of the area of each of one or more peaks appearing at the retention factor 7 or more and less than 16.

It is noted that the total value of the area of each of one or more peaks appearing in the range of the retention factors 7 or more and less than 16 corresponds to the content proportion of the addition condensation product with a relatively small average molecular weight. The total value of the area of each of one or more peaks appearing in the range of the retention factors 16 or more and 25 or less corresponds to the content proportion of the addition condensation product with a relatively large average molecular weight.

### (The Constitution of Addition Condensation Product Included in the Scale Adhesion Prevention Layer)

For each of practical examples 2, 4, 6, and 8, and comparative example 2, the constitution of the addition condensation product included in the scale adhesion prevention layer is determined by the high performance liquid chromatography analysis method. Specifically, the content ratio of the first condensation product to the second condensation product described above (sometimes referred to as a content ratio in a coating film) is derived. Table 1 indicates the derivation result related to each of practical examples 2, 4, 6, and 8, and comparative example 2. In the column of “content ratio in coating film” in Table 1, dash symbols indicate that the content ratio is not derived.

The apparatus and measurement condition used for the high performance liquid chromatography are similar to those of the derivation procedure of the content ratio in the coating liquid. It is noted that the sample of the scale adhesion prevention layer is collected according to the procedure described below. The measurement of the retention time t_{R} of each component included in the sample of the scale adhesion prevention layer is performed according to the procedure described below. The content ratio in the coating film is derived according to the procedure described below.

### (Collection of a Sample of the Scale Adhesion Prevention Layer)

In each practical example and each comparative example, the location in which the scale adhesion prevention layer is formed is confirmed by confirming the inside of the polymerization vessel through visual observation. Then, the sample of the scale adhesion prevention layer is obtained by scrubbing the swab impregnated with N-methyl-2-pyrrolidone (sometimes referred to as NMP) against the square-shaped area with a range of 10 cm×10 cm inside the scale adhesion prevention layer.

Then, a solvent is prepared to collect NMP solution including an addition condensation product from the swab described above by mixing 10.0 mL of NMP and 20 μL of 0.5 N hydrochloric acid. Then, a 100 μl aliquot of the solvent described above is dripped onto the swab described above 10 times and the rinse liquid is collected. In this way, the sample of the scale adhesion prevention layer according to each practical example and each comparative example is obtained.

### (Measurement of Retention Time t_{R} of Each Component Included in the Sample of the Scale Adhesion Prevention Layer)

First, the filtrate is obtained by filtering the sample described above according to each practical example and each comparative example using a polytetrafluoroethylene filter with a pore diameter of 0.45 μm. Then, the filtrate described above is set to the chromatograph described above and the measurement of the retention time t_{R} is started. The measurement condition of the retention time t_{R} is the same as the measurement condition of the holdup time t_{O} described above.

### (The Content Ratio in the Coating Film)

First, the retention factor of each of the plurality of peaks appearing on each chromatogram of each practical example and each comparative example is derived based on the holdup time t_{O} and the retention time t_{R} of each component included in the sample of the scale adhesion prevention layer formed in each practical example and each comparative example. Then, the content ratio in the coating film is derived by dividing the total value of the area of each of one or more peaks appearing in the range of the retention factors 16 or more and 25 or less by the total value of the area of each of one or more peaks appearing in the range of the retention factors 7 or more and less than 16.

TABLE 1

| | | | CONTENT | CONTENT | SCALE | NUMBER |
|---|---|---|---|---|---|---|
| | FIRST | SECOND | RATIO IN | RATIO IN | ADHESION | OF |
| | COATING | COATING | COATING | COATING | PREVENTION | FOREIGN |
| NO | LIQUID | LIQUID | LIQUID | FILM | PERFORMANCE | OBJECTS |
| PRACTICAL | NO. 1-1 | UNUSED | — | — | ∘ | — |
| EXAMPLE 1 | | | | | | |
| PRACTICAL | NO. 1-1 | NO. 2-1 | 2.8 | 0.85 | ∘ | 2 |
| EXAMPLE 2 | | | | | | |
| PRACTICAL | NO. 1-2 | UNUSED | — | — | ∘ | — |
| EXAMPLE 3 | | | | | | |
| PRACTICAL | NO. 1-2 | NO. 2-1 | 3.0 | 1.10 | ∘ | — |
| EXAMPLE 4 | | | | | | |
| PRACTICAL | NO. 1-3 | UNUSED | — | — | ∘ | — |
| EXAMPLE 5 | | | | | | |
| PRACTICAL | NO. 1-3 | NO. 2-1 | 2.9 | 0.9 | ∘ | — |
| EXAMPLE 6 | | | | | | |
| PRACTICAL | NO. 1-4 | UNUSED | — | — | ∘ | — |
| EXAMPLE 7 | | | | | | |
| PRACTICAL | NO. 1-4 | NO. 2-1 | 3.1 | 1.15 | ∘ | — |
| EXAMPLE 8 | | | | | | |
| COMPARATIVE | NO. 1-5 | UNUSED | — | — | x | — |
| EXAMPLE 1 | | | | | | |
| COMPARATIVE | NO. 1-5 | NO. 2-1 | 2.2 | 0.71 | x | 10 |
| EXAMPLE 2 | | | | | | |
| COMPARATIVE | NO. 1-6 | UNUSED | — | — | Δ | — |
| EXAMPLE 3 | | | | | | |
| COMPARATIVE | NO. 1-6 | NO. 2-1 | — | — | Δ | — |
| EXAMPLE 4 | | | | | | |
| COMPARATIVE | NO. 1-7 | UNUSED | — | — | Δ | — |
| EXAMPLE 5 | | | | | | |
| COMPARATIVE | NO. 1-7 | NO. 2-1 | — | — | Δ | — |
| EXAMPLE 6 | | | | | | |

As indicated in Table 1, the composition used as a scale adhesion prevention agent includes a thiol compound so that the scale adhesion prevention layer has an excellent scale adhesion prevention effect even if the scale adhesion prevention layer is produced by a steam coating method. In this way, the decrease in heat removal efficiency of the polymerization vessel is suppressed. In addition, the contamination of the foreign object in the product is suppressed. As a result, the yield of the product improves.

In addition, as indicated in Table 1, the scale adhesion prevention effect of the scale adhesion prevention layer decreases in comparative examples 1 to 6 related to the coating liquid including antioxidants such as sodium dithionite, L-ascorbic acid, N,N-diethylhydroxylamine or the like. In this way, it is understood that the thiol compound is a particularly excellent additive of the composition including an addition condensation product of an aromatic compound and a carbonyl compound, compared to antioxidants or among antioxidants.

While the present invention has been described by way of the embodiments, the technical scope of the present invention is not limited to the embodiments described above. It is apparent to persons skilled in the art that various alterations or improvements can be made to the embodiments described above. In addition, the matters described with regard to the particular embodiment can be applied to other embodiments with a range without causing technical contradictions. It is also apparent from the description of the claims that the embodiments to which such alterations or improvements are made can be included in the technical scope of the present invention.

It should be noted that the operations, procedures, steps, stages, and the like of each process performed by an apparatus, system, program, and method shown in the claims, the specification, or the drawings can be realized in any order as long as the order is not indicated by “prior to,” “before,” or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

100 polymerization apparatus
110 reaction vessel
112 body
114 inner surface
116 scale prevention layer
120 stirrer
122 stirring shaft
124 stirring blade
126 power mechanism
130 baffle
132 body
134 support
140 cooling tube
170 jacket
172 flow channel
180 reflux condenser
182 flow channel
190 coating apparatus
212 coating liquid supply unit
214 rinse water supply unit
220 coating nozzle
222 line
230 first coating liquid storage tank
232 pump
234 line
236 valve
240 second coating liquid storage tank
242 pump
244 line
246 valve
250 steam supply source
254 line
256 valve
260 rinse nozzle
270 rinse water storage tank
272 pump
274 line
276 valve.

What is claimed is:

1. A composition comprising:
an addition condensation product of an aromatic compound and a carbonyl compound; and
a thiol compound.

2. The composition according to claim 1, wherein the composition includes 0.01 parts by mass or more and 100 parts by mass or less of the thiol compound per 100 parts by mass of the aromatic compound.

3. The composition according to claim 1, wherein the addition condensation product includes:
a first type of addition condensation product having a first average molecular weight; and
a second type of addition condensation product having a second average molecular weight, and
the first average molecular weight and the second average molecular weight are different from each other.

4. The composition according to claim 3, wherein a ratio of a mass of the second type of addition condensation product to a mass of the first type of addition condensation product is 2.3 to 1000, and
the second average molecular weight is greater than the first average molecular weight.

5. The composition according to claim 1, wherein the thiol compound includes:
a thiol group; and
at least one functional group selected from a group consisting of a hydroxyl group, an amino group, and a carboxyl group.

6. The composition according to claim 1, wherein the thiol compound is thioglycerol, thioglycol, or derivatives thereof.

7. The composition according to claim 1, wherein the aromatic compound is naphthols.

8. The composition according to claim 1, wherein the carbonyl compound is an aldehyde compound, a ketone compound, or derivatives thereof.

9. The composition according to claim 1, wherein the aromatic compound is 1-naphthol,
the carbonyl compound is formaldehyde, and
the thiol compound is 1-thioglycerol or thioglycol.

10. The composition according to claim 1, wherein the thiol compound is not a thiourea tautomer.

11. A scale adhesion prevention agent for preventing adhesion of scale including a polymer, comprising:
the composition according to claim 1.

12. A scale adhesion prevention agent for preventing adhesion of scale including a polymer, comprising:
the composition according to claim 2.

13. A method for producing the composition according to claim 1, comprising:
preparing a mixture of a solvent, an aromatic compound, a carbonyl compound, and a thiol compound; and
producing a composition comprising an addition condensation product of the aromatic compound and the carbonyl compound, and the thiol compound by causing the aromatic compound and the carbonyl compound included in the mixture to react in a presence of a catalyst and a surfactant.

14. The method for producing the composition according to claim 13, wherein
the catalyst is alkali metal hydroxide, and
the surfactant is an anionic surfactant.

15. The method for producing the composition according to claim 13, wherein the thiol compound is not a thiourea tautomer.

16. A scale adhesion prevention layer formed of the composition according to claim 1 on an internal structure surface of a reactor included in a reaction apparatus for polymerization of monomers.

17. A reaction apparatus comprising a reactor having an internal structure in which the scale adhesion prevention layer according to claim 16 is formed on a surface.

18. A reaction apparatus for polymerization of monomers, comprising a reactor configured to be able to store solution including the monomers, wherein
the reactor includes a covering layer arranged on at least part of an inner wall surface that is a surface on a side contacting the solution,
the covering layer includes an addition condensation product of an aromatic compound and a carbonyl compound,
the addition condensation product includes:
a first type of addition condensation product having a first average molecular weight; and
a second type of addition condensation product having a second average molecular weight;
the second average molecular weight is greater than the first average molecular weight, and
a ratio of a mass of the second type of addition condensation product to a mass of the first type of addition condensation product is 0.75 to 1000.

19. A method for producing a polymer, comprising:
preparing the reaction apparatus according to claim 18;
charging a solution including monomers inside a reactor of the reaction apparatus;
starting a polymerization reaction of the monomers inside the reactor; and
terminating a polymerization reaction of the monomers inside the reactor.

20. A particulate polymer, wherein
a number of foreign objects with a major axis of 250 μm or more included per 200 cm³ of the polymer that is measured according to JIS K 6737 is two or more and four or less, and
a content of an addition condensation product of an aromatic compound and a carbonyl compound in the foreign object is 1% by mass or more.
